(19) United States
(12) Patent Application Publication
(10) Pub. No.: US 2011/0022406 A1
(43) Pub. Date: Jan. 27, 2011

(54) Apparatus and method for providing security in an online gaming and/or digital environment

(76) Inventor: Barbara Ann Fox, Palm Beach Gardens, FL (US)

Correspondence Address: BARBARA ANN FOX, 394 ISLE COURT, PALM BEACH GARDENS, FL, 33418, US

(21) Appl. No.: 12/804,488

(22) Filed: Jul. 22, 2010

Related U.S. Application Data
(60) Provisional application No. 61/271,851, filed on Jul. 27, 2009.

(51) Int. Cl. G06Q 99/00; G06Q 30/00; G06Q 40/00

(52) U.S. Cl. 705/1.1

(57) ABSTRACT

An apparatus and method for providing security and protecting against loss in an online gaming or digital environment pertaining to the integrity, performance, functionality, usability, or existence of a digital asset, digital identity, and/or digital entity. Processing information for an exchange-of-risk-for-consideration, including a memory device for storing information for generating any one of a probability weighted pricing for a exchange-of-liabilities agreement and an agreement for providing such an exchange-of-risk-for-consideration for any one of loss, damage, interruption, deletion, disruption, corruption, theft, misappropriation, unauthorized copying, unauthorized access, unauthorized use, improper use, defacing, defaming, maligning, misrepresenting, wrongly portraying, impersonating, etc., and/or maintenance relating to the existence, function and/or use of a digital asset, digital identity, or digital entity; and a processor for generating information concerning any one of an probability weighted pricing for a exchange-of-liabilities agreement for providing a exchange-of-liabilities agreement or a exchange-of-liabilities product, and a device for displaying or outputting information concerning the risk exchange probability weighted pricing, the exchange-of-liabilities agreement, or the exchange-of-liabilities product; and the processor generating a data set containing information regarding any one of a liability and/or loss, a potential liability and/or loss, and a risk of loss, associated with the exchange-of-liabilities agreement or the exchange-of-liabilities product; and a processor for processing information to enable derivative credit products and/or services to be written based upon such exchange-of-liabilities agreements and products.

### FIELD OF THE INVENTION

The present invention pertains to an apparatus and method for providing security and protecting against loss in an online gaming or digital environment pertaining to the integrity, performance, functionality, usability, or existence of a digital asset, digital identity, and/or digital entity. Processing information for an exchange-of-risk-for-consideration, including a memory device for storing information for generating any one of a probability weighted pricing for a risk exchange and an agreement for providing such an exchange-of-risk-for-consideration for any one of loss, damage, interruption, deletion, disruption, corruption, theft, misappropriation, unauthorized copying, unauthorized access, unauthorized use, improper use, defacing, defaming, maligning, misrepresenting, wrongly portraying, impersonating, etc., and/or maintenance relating to the existence, function and/or use of a digital asset, digital identity, or digital entity; and a processor for generating information concerning any one of an probability weighted pricing for a exchange-of-liabilities agreement for providing a exchange-of-liabilities agreement or a exchange-of-liabilities product, and a device for displaying or outputting information concerning the risk exchange probability weighted pricing, the exchange-of-liabilities agreement, or the exchange-of-liabilities product; and the processor generating a data set containing information regarding any one of a liability and/or loss, a potential liability and/or loss, and a risk of loss, associated with the exchange-of-liabilities agreement or the exchange-of-liabilities product; and a processor for processing information to enable derivative credit products and/or services to be written based upon such exchange-of-liabilities agreements and products.

### BACKGROUND OF THE INVENTION

In recent times, a growing number of individuals and businesses have turned to creating and relying upon digital assets, digital entities, digital identities, digital currencies, applications, applets, digital audio, digital video, digital text, data, information, algorithms, programs, online stores, virtual worlds, avatars, virtual characters, electronic books, video files, e-magazines, e-tickets, e-documents, etc., which exist in games, and/or gaming, and/or entertainment, and/or education, and/or business, and/or as elements of other forms of utility in digital environments which may be assets in commerce, entertainment, gaming, music, video, and the like, which constitute an asset, and/or class of assets, in digital form and which may be consumed, created, processed, transmitted, transacted, and/or stored on a multitude of computing devices, servers, mobile devices, laptop computers, hand-held computers, gaming devices, storage area networks, personal area networks, in datacenters, managed networks, and accessed and/or utilized through the Internet, Worldwide Web, intranets, extranets, and various other communications networks.

The use, creation, and operation of such digital assets, identities, and entities, however, create a potential liability and/or loss for the owners, user, creator, operator, and/or service provider of such digital assets, identities, and entities with respect to the care and well-being of such digital assets, identities, and entities with respect to a potential loss, damage, interruption, deletion, disruption, corruption, theft, misappropriation, unauthorized copying, unauthorized access, unauthorized use, improper use, defacing, defaming, maligning, misrepresenting, wrongly portraying, impersonating, etc., and/or maintenance. The loss, damage, interruption, deletion, disruption, corruption, theft, misappropriation, unauthorized copying, unauthorized access, unauthorized use, improper use, defacing, defaming, maligning, misrepresenting, wrongly portraying, impersonating, etc., and/or maintenance creates a liability and/or loss for the aforementioned parties, which is typically not acceptable to the other parties having ownership or dependency on the proper and full functional availability of the digital assets, digital identities, and/or digital entities as intended.

The ability to effectively and efficiently secure digital assets can lead to the development of products and services in the United States and throughout the rest of the world that would benefit industry and individuals. Throughout past decades, innovations in security technologies have enabled the founding and growth of industries and improved lives of an increasing number of individuals

The inefficiencies associated with the current systems may be characterized by out-of-date technological solutions, outmoded techniques, legacy operational models, and traditional business models that do not recognize or support the underlying value and/or risk associated with digital assets. By enabling a security mechanism with transparent, controllable, and market oriented functionality digital commerce transactions and asset accumulation will be accessible by many more individuals and entities. The net benefit would accrue in terms of security, transparency, performance, cost, and time.

### SUMMARY OF THE INVENTION

The present invention provides an apparatus and a method for overcoming the shortfalls of the prior art and provides an apparatus and a method for providing security for digital assets through the use of products, services and/or coverage which provides pecuniary coverage for protecting individuals and/or entities from loss and/or liability and/or loss which may arise as the result of systems failure, process failure, product failure, service failure, and/or damage which may occur to a digital asset, digital identity, or digital entity.

The apparatus comprises a central processing unit, a read only memory device, a random access memory device, a user input device(s), a display device, an output device and a database. The database contains data and/or information which is relevant to determining exchange-of-risk-for-consideration policies and premiums related to the use, creation, and operation of such digital assets, identities, and entities, personal and/or commercial, which may be the subject of an asset, service, opportunity, and/or other loss, damage, interruption, deletion, disruption, corruption, theft, misappropriation, unauthorized copying, unauthorized access, unauthorized use, improper use, defacing, defaming, maligning, misrepresenting, wrongly portraying, impersonating, etc., and/or maintenance.

Data and/or information, which is related to digital asset, digital identity, or digital entity loss, damage, interruption, deletion, disruption, corruption, theft, misappropriation, unauthorized copying, unauthorized access, unauthorized use, improper use, defacing, defaming, maligning, misrepresenting, wrongly portraying, impersonating, etc., and/or maintenances, includes asset components, uses, computer code, contextual usage information, owner, creator, user, renter, service provider, and/or systems information along with actual or algorithmically calculated replacement costs, repair and/or replacement costs, value, probability of damage, probability of maintenance and/or repairs and/or replacements necessitated by damage, malfunctioning components and/or systems and defects in computer code, components, materials, systems and/or workmanship, average costs and/or algorithmically calculated costs for repairs and/or replacements, including costs of typical repairs and/or replacements, average costs and/or value for the entire asset. Digital asset, digital identity, digital entity data and/or information also includes locality, regional and geographical data which is correlated with cost and value and data and/or information which is related to usage patterns, and/or usage patterns in particular geographic areas and/or contexts. Data and information related to individuals and/or entities, by region, occupation industry, including usage habits, usage histories, will also be included in the database.

The database will also include data and/or information for particular individuals and/or entities which includes personal, individual and/or organizational use, creation, and/or operation patterns and/or histories and/or habits as well as any other information which an seller, originator, and/or broker of exchange-of-risk-for-consideration agreements may deem necessary and/or desirable in determining whether exchange-of-risk-for-consideration agreement should be offered to an individual and/or entity.

The database also includes data and/or information for particular individuals and/or entities which includes personal, individual and/or organizational use habits and/or patterns and/or use histories and leasing, renting, using, owning, transacting, and/or management histories as well as any other information which an seller, originator, and/or broker of exchange-of-risk-for-consideration agreements may deem necessary and/or desirable in determining whether exchange-of-risk-for-consideration agreement should be offered to an individual and/or entity.

The database also includes all necessary actuarial, statistical and related data and/or information necessary in performing the calculations and analysis deemed necessary in underwriting and issuing a exchange-of-risk-for-consideration agreement and/or coverage, including premium determination for any of the herein described exchange-of-risk-for-consideration policies, products, services and/or coverage.

As noted above, the present invention provides an apparatus and a method for providing exchange-of-risk-for-consideration policies, products, services and/or coverage for protection against loss and/or liability and/or loss which may arise as the result of loss, damage, interruption, deletion, disruption, corruption, theft, misappropriation, unauthorized copying, unauthorized access, unauthorized use, improper use, defacing, defaming, maligning, misrepresenting, wrongly portraying, impersonating, etc., and/or maintenance and/or repairs and/or replacements. In this regard, individuals and/or entities may obtain exchange-of-risk-for-consideration so as to protect themselves from liabilities which might arise from the loss, damage, interruption, deletion, disruption, corruption, theft, misappropriation, unauthorized copying, unauthorized access, unauthorized use, improper use, defacing, defaming, maligning, misrepresenting, wrongly portraying, impersonating, etc., and/or maintenance and/or repairs and/or replacements of a digital asset, digital identity, or digital entity, which may have experienced the loss, damage, interruption, deletion, disruption, corruption, theft, misappropriation, unauthorized copying, unauthorized access, unauthorized use, improper use, defacing, defaming, maligning, misrepresenting, wrongly portraying, impersonating, etc., and/or need for maintenance and/or repair during the use, creation, operation, and/or ownership term.

The present invention can also provide exchange-of-risk-for-consideration policies, products, services and/or coverage for any of the herein-described entities while providing an incentive and/or incentives, to individuals and/or entities, for minimizing loss, damage, interruption, deletion, disruption, corruption, theft, misappropriation, unauthorized copying, unauthorized access, unauthorized use, improper use, defacing, defaming, maligning, misrepresenting, wrongly portraying, impersonating, etc., and/or need for maintenance and/or repair by providing for a commensurate rebate of a portion of an agreement for providing premiums or charges, at the end of the loss, damage, interruption, deletion, disruption, corruption, theft, misappropriation, unauthorized copying, unauthorized access, unauthorized use, improper use, defacing, defaming, maligning, misrepresenting, wrongly portraying, impersonating, etc., or maintenance and/or repair term. In this regard, an individual and/or entity may choose to elect a exchange-of-risk-for-consideration agreement for providing with an incentive program so that a portion of an agreement for providing premium or charges will be refunded to him, her, or it, respectively, when and if the entity is returned with no and/or minimal loss, damage, interruption, deletion, disruption, corruption, theft, misappropriation, unauthorized copying, unauthorized access, unauthorized use, improper use, defacing, defaming, maligning, misrepresenting, wrongly portraying, impersonating, etc., and/or need for maintenance and/or repair. Such an incentive program would serve to reward individuals and/or entities who and/or which, respectively, maintain the entity, during the loss, damage, interruption, deletion, disruption, corruption, theft, misappropriation, unauthorized copying, unauthorized access, unauthorized use, improper use, defacing, defaming, maligning, misrepresenting, wrongly portraying, impersonating, etc., or maintenance and/or repair term, so that the entity is maintained with no additional loss, damage, interruption, deletion, disruption, corruption, theft, misappropriation, unauthorized copying, unauthorized access, unauthorized use, improper use, defacing, defaming, maligning, misrepresenting, wrongly portraying, impersonating, etc., and/or need for maintenance and/or repair compensation.

In another embodiment, the apparatus of the present invention is utilized in a network environment so as to provide exchange-of-risk-for-consideration policies, products, services and/or coverage in, and over, a network such as on, or over, the Internet, the World Wide Web and/or any other communications network and/or system.

In another embodiment, the apparatus and method of the present invention can be utilized in order to create a derivative credit product and/or service which is based on any liability and/or loss or liabilities which can be created by, or which can be potentially created by, any of the loss, damage, interruption, deletion, disruption, corruption, theft, misappropriation, unauthorized copying, unauthorized access, unauthorized use, improper use, defacing, defaming, maligning, misrepresenting, wrongly portraying, impersonating, etc., or maintenance exchange-of-risk-for-consideration policies, products, and/or instruments, which can be provided pursuant to, and/or facilitated by, the present invention.

The apparatus of the present invention can identify the loss, damage, interruption, deletion, disruption, corruption, theft, misappropriation, unauthorized copying, unauthorized access, unauthorized use, improper use, defacing, defaming, maligning, misrepresenting, wrongly portraying, impersonating, etc., or maintenance exchange-of-risk-for-consideration agreement for providing or loss, damage, interruption, deletion, disruption, corruption, theft, misappropriation, unauthorized copying, unauthorized access, unauthorized use, improper use, defacing, defaming, maligning, misrepresenting, wrongly portraying, impersonating, etc., or maintenance exchange-of-risk-for-consideration product which is being offered and can ascertain the liability and/or loss, the potential liability and/or loss, or the risk of loss, which is or which may be associated with the loss, damage, interruption, deletion, disruption, corruption, theft, misappropriation, unauthorized copying, unauthorized access, unauthorized use, improper use, defacing, defaming, maligning, misrepresenting, wrongly portraying, impersonating, etc., or maintenance exchange-of-risk-for-consideration agreement for providing or the loss, damage, interruption, deletion, disruption, corruption, theft, misappropriation, unauthorized copying, unauthorized access, unauthorized use, improper use, defacing, defaming, maligning, misrepresenting, wrongly portraying, impersonating, etc., or maintenance exchange-of-risk-for-consideration product.

The apparatus of the present invention can also identify a derivative credit product and/or service which can be created and issued to investors in order to reduce the liability and/or loss or risk of loss associated with the loss, damage, interruption, deletion, disruption, corruption, theft, misappropriation, unauthorized copying, unauthorized access, unauthorized use, improper use, defacing, defaming, maligning, misrepresenting, wrongly portraying, impersonating, etc., or maintenance exchange-of-risk-for-consideration agreement for providing or product. The derivative credit product and/or service can be any one or more of a bond, a note, a securitized bond, a securitized note, an exchange, a credit exchange, an option, a credit option, a put option, a call option, a credit-linked note, a total return exchange, a default exchange, an exotic option, an exotic credit option, an exchange option or an exchange option, a total rate of return exchange, a loan exchange, a credit exchange, or any other instrument which can be utilized as a derivative credit product and/or service.

The apparatus of the present invention can also determine the price or pricing of the derivative credit product and/or service, derivative credit products and/or services, or derivative credit product and/or service units, for the identified derivative credit product and/or service. The apparatus of the present invention can also determine and/or generate the offering terms (e.g. time for holding the derivative credit product and/or service, time to maturity of the derivative credit product and/or service instrument, interest rate of the derivative credit product and/or service, rate of return of the derivative credit product and/or service, default risk information, issuer default risk, probability of default by the issuer of the derivative credit product and/or service, probability of non-default by the issuer, and any other terms or information which can be typically provided along with a derivative credit product and/or service or other investment or pecuniary instrument, etc.).

The apparatus of the present invention can output the information the identified derivative credit product and/or service and the information regarding the pricing and/or offering terms for the derivative credit product and/or service, derivative credit products and/or services, or derivative credit product and/or service units. The derivative credit product(s) and/or service(s) can then be issued to investors.

Accordingly, it is an object of the present invention to provide an apparatus and method for providing exchange-of-risk-for-consideration policies, products, services and/or coverage for loss, damage, interruption, deletion, disruption, corruption, theft, misappropriation, unauthorized copying, unauthorized access, unauthorized use, improper use, defacing, defaming, maligning, misrepresenting, wrongly portraying, impersonating, etc., and/or maintenance and/or repairs and/or replacements for entities for providing exchange-of-risk-for-consideration protection against loss and/or liability and/or loss which may arise as the result of an asset, service, opportunity, and/or other loss, damage, interruption, deletion, disruption, corruption, theft, misappropriation, unauthorized copying, unauthorized access, unauthorized use, improper use, defacing, defaming, maligning, misrepresenting, wrongly portraying, impersonating, etc., and/or maintenance and/or repair requirement during the coverage term for the digital asset, identity, or asset for loss, damage, interruption, deletion, disruption, corruption, theft, misappropriation, unauthorized copying, unauthorized access, unauthorized use, improper use, defacing, defaming, maligning, misrepresenting, wrongly portraying, impersonating, etc., and/or maintenance and/or repair.

It is another object of the present invention to provide an apparatus and method for providing exchange-of-risk-for-consideration policies, products, services and/or coverage for loss, damage, interruption, deletion, disruption, corruption, theft, misappropriation, unauthorized copying, unauthorized access, unauthorized use, improper use, defacing, defaming, maligning, misrepresenting, wrongly portraying, impersonating, etc., and/or maintenance and/or repairs and/or replacements for digital assets, identities, and entities for providing exchange-of-risk-for-consideration protection against loss and/or liability and/or loss which may arise as the result of post-warranty, guaranty, service-level-agreement, and/or performance-assurance maintenance and/or repairs and/or replacements.

It is another object of the present invention to provide an apparatus and a method for providing exchange-of-risk-for-consideration policies, products, services and/or coverage for loss, damage, interruption, deletion, disruption, corruption, theft, misappropriation, unauthorized copying, unauthorized access, unauthorized use, improper use, defacing, defaming, maligning, misrepresenting, wrongly portraying, impersonating, etc., and/or maintenance and/or repairs and/or replacements for digital assets, digital identities, and/or digital entities which is implemented using software in conjunction with a computer and/or a processing system.

It is yet another object of the present invention to provide an apparatus and a method for providing exchange-of-risk-for-consideration policies, products, services and/or coverage for loss, damage, interruption, deletion, disruption, corruption, theft, misappropriation, unauthorized copying, unauthorized access, unauthorized use, improper use, defacing, defaming, maligning, misrepresenting, wrongly portraying, impersonating, etc., and/or maintenance and/or repairs and/or replacements which provides incentives for maintaining the digital asset, digital identity, and/or digital entity against loss, damage, interruption, deletion, disruption, corruption, theft, misappropriation, unauthorized copying, unauthorized access, unauthorized use, improper use, defacing, defaming, maligning, misrepresenting, wrongly portraying, impersonating, etc., and/or maintenance and/or repair claims, with no and/or minimum loss, damage, interruption, deletion, disruption, corruption, theft, misappropriation, unauthorized copying, unauthorized access, unauthorized use, improper use, defacing, defaming, maligning, misrepresenting, wrongly portraying, impersonating, etc., and/or maintenance and/or repairs and/or replacements during the coverage term.

It is yet another object of the present invention to provide an apparatus and a method for providing exchange-of-risk-for-consideration policies, products, services and/or coverage for loss, damage, interruption, deletion, disruption, corruption, theft, misappropriation, unauthorized copying, unauthorized access, unauthorized use, improper use, defacing, defaming, maligning, misrepresenting, wrongly portraying, impersonating, etc., and/or maintenance and/or repairs and/or replacements for digital assets, identities, entities on, or over, a communication network such as on, or over, the Internet, the World Wide Web and/or any other communications and/or network environment and/or medium.

It is another object of the present invention to create a derivative credit product and/or service which is based on any liability and/or loss or liabilities which can be created by, or which can be potentially created by, any of the loss, damage, interruption, deletion, disruption, corruption, theft, misappropriation, unauthorized copying, unauthorized access, unauthorized use, improper use, defacing, defaming, maligning, misrepresenting, wrongly portraying, impersonating, etc., and/or maintenance and/or repairs and/or replacements for digital assets, digital entities, digital identities, etc., exchange-of-risk-for-consideration policies, products, and/or instruments, which can be provided pursuant to, and/or facilitated by, the present invention.

It is still another object of the present invention to create a derivative credit product and/or service which can be utilized to provide a off-set of the risk associated with for, to provide exchange-of-risk-for-consideration for, or to provide exchange-of-risk-for-considerations for underwritten exchange-of-risk-for-considerations issued by other entities for, any liability and/or loss, potential liability and/or loss, or risk of loss, damage, interruption, deletion, disruption, corruption, theft, misappropriation, unauthorized copying, unauthorized access, unauthorized use, improper use, defacing, defaming, maligning, misrepresenting, wrongly portraying, impersonating, etc., and/or maintenance and/or repairs and/or replacements for digital assets, digital entities, digital identities, etc., exchange-of-risk-for-consideration policies, products, and/or instruments, which can be provided pursuant to, and/or facilitated by, the present invention.

It is yet another object of the present invention to provide price information, pricing information, and/or offering terms information, for a derivative credit product and/or service which can be utilized to provide an off-set of the risk associated with the providing of exchange-of-risk-for-consideration for, or to provide exchange-of-risk-for-considerations for underwritten exchange-of-risk-for-considerations issued by other entities for, any liability and/or loss, potential liability and/or loss, or risk of loss, damage, interruption, deletion, disruption, corruption, theft, misappropriation, unauthorized copying, unauthorized access, unauthorized use, improper use, defacing, defaming, maligning, misrepresenting, wrongly portraying, impersonating, etc., and/or maintenance and/or repairs and/or replacements for digital assets, digital entities, digital identities, etc., exchange-of-risk-for-consideration policies, products, and/or instruments, which can be provided pursuant to, and/or facilitated by, the present invention.

Other objects and advantages of the present invention will be apparent to those individuals skilled in the art upon a review of the Description of the Preferred Embodiment taken in conjunction with the Drawings which follow.

### BRIEF DESCRIPTION OF THE DRAWINGS

In the Drawings:

FIG. 1 illustrates a block diagram of the apparatus which is the subject of the present invention;

FIGS. 2A and 2B illustrate a flow diagram of a preferred embodiment method of operation of, or method for utilizing, the apparatus of the present invention;

FIGS. 3A and 3B illustrate a flow diagram of another embodiment method of operation of, or method for utilizing, the apparatus of the present invention;

FIGS. 4A and 4B illustrate a flow diagram of another embodiment method of operation of, or method for utilizing, the apparatus of the present invention;

FIG. 5 illustrates another embodiment of the apparatus of the present invention which is utilized in a network environment; and

FIG. 6 illustrates a flow diagram of a method for utilizing the present invention in order to create and/or to price a derivative credit product and/or service corresponding to any liability and/or loss or potential liability and/or loss associated with a lease, rental, use, ownership, transaction, service providing, and/or management exchange-of-risk-for-consideration-agreement or lease, rental, use, ownership, transaction, service providing, and/or management exchange-of-risk-for-consideration product.

### DESCRIPTION OF THE PREFERRED EMBODIMENTS

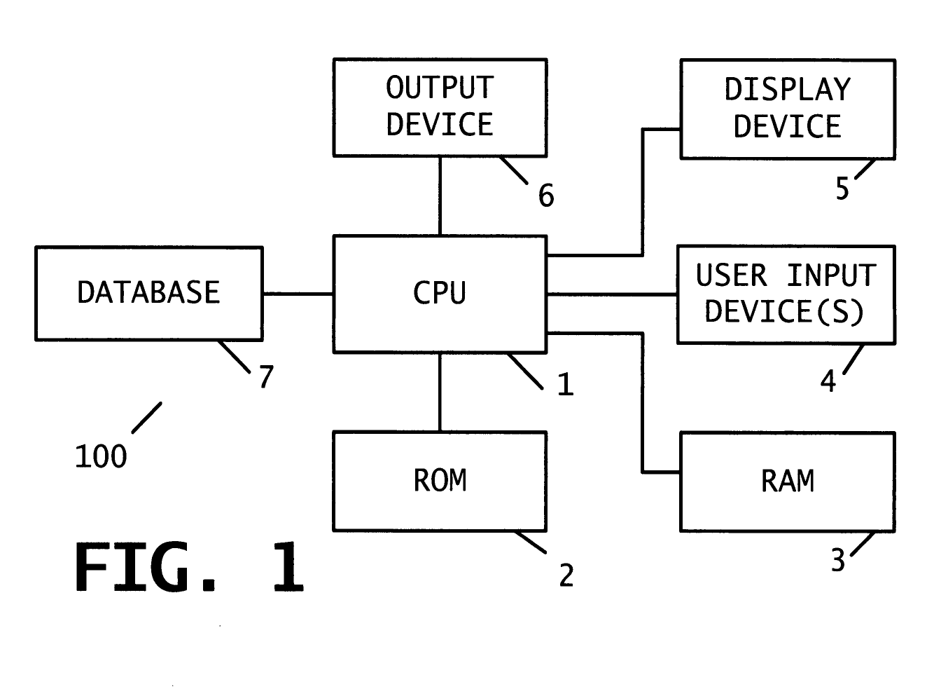

FIG. 1 illustrates a block diagram of the apparatus which is the subject of the present invention and which is denoted generally by the reference numeral 100. The apparatus 100 comprises a central processing unit (CPU) 1 which, in the preferred embodiment, is a microprocessor. The CPU 1 may also be a computer(s) and/or computer systems, server, network computer, mainframe computer, mini-computer, personal computer, a microcomputer, a computer on a chip, a nano computer, a quantum computer, a website, a blog, SMS, an instant message, a tweet, a posting, an application, an applet, and/or any other computer and/or computer system which is suitable for performing the respective processing functions of the respective computers in a network environment. The CPU 1 may also be implemented as a server computer in a network configuration. The CPU1 may also be implemented on and/or over a multitude of computing devices, servers, mobile devices, laptop computers, hand-held computers, gaming devices, storage area networks, personal area networks, in datacenters, managed networks, and accessed by any suitable device and/or utilized in conjunction with the Internet, Worldwide Web, intranets, extranets, and various other communications networks.

The apparatus 100 also comprises a read only memory (ROM) 2 and a random access memory (RAM) 3 which are also connected to the CPU 1. The apparatus 100 also comprises a user input device(s) 4 which comprise(s) any one or more of a key pad, a keyboard, a scanner, a touch pad, a signature pad, a card reader, a magnetic strip card reader, a biometric scanner, a subscriber identity module reader, a chip reader, a signal scanner, a camera, a video camera, a microphone, a graphic image and/or video signal generator, an audio signal and/or audio image generator, a user pointing device, such as, for example, a mouse, a touch pad, and/or an audio input device and/or a video input device, or the like, if desired, which input device(s) is also connected to the CPU 1. The apparatus 100 also comprises a display device 5, such as a display monitor, which is also connected to the CPU 1, and an output device 6, such as a printer, a presentation, a display, an audio signal, a video signal, a text signal, a graphical signal, a read-out, a presenter, a 3-dimentional printer, a router, a modem, a networking device, a fax/modem, a transmitting device, or other output device, for providing data and/or information, etc., which output device is also connected to the CPU 1.

The apparatus 100 also comprises a database(s) 7, wherein various information and/or data, which is utilized in the various processing routines, as will be described herein, is stored and which is also connected to, and accessible by, the CPU 1. Various data and/or information related to the leasing, renting, using, owning, transacting, and/or management of digital assets, digital entities, digital identities, digital currencies, applications, applets, digital audio, digital video, digital text, data, information, algorithms, programs, etc., including articles and/or equipment which may be utilized in, and/or in conjunction with online and/or digital environments, is stored in the database 7. The database 7 also includes data and/or information related to the leases of online and/or digital environments.

Data and/or information related to digital asset, digital entity, and/or digital identity leases, rentals, uses, ownerships, transactions and/or management which is included in the database 7, includes digital asset, digital entity, and/or digital identity metadata, date of creation, creator, owner, licensor, licensee, terms of license, ownership history, termination history, transaction history, description, identifying codes and/or information, etc., digital asset, digital entity, and/or digital identity components and/or systems along with their replacement costs, repair and/or replacement costs, probability of damage, probability of post-warranty, guaranty, service-level-agreement, and/or performance-assurance repairs and/or replacements necessitated by usage, creation, consumption, transaction, and/or storage, damage, malfunctioning components and/or systems and defects in materials, parts, components, systems and/or workmanship, average costs for repairs and/or replacements, historical leasing, renting, using, owning, transacting, and/or management data, average total damage, deletion, corruption, unauthorized use, usage, creation, consumption, transaction, and/or storage, etc., of an improper nature costs for the entire digital asset, digital entity, and/or digital identity. Digital asset, digital entity, and/or digital identity leasing, renting, using, owning, transacting, and/or management data and/or information also includes locality, regional and geographical data which is correlated with damage, deletion, corruption, unauthorized use, usage, creation, consumption, transaction, and/or storage, etc., of an improper nature costs along with data and/or information which is related to usage habits and/or patterns in a given area or areas. Data and information related to individuals and/or entities, by region, occupation, use, technical attributes, service histories, financial histories, etc., including usage habits, leasing, renting, using, owning, transacting, and/or management histories, etc., will also be included in the database 7.

Usage, creation, consumption, transaction, and/or storage and damage, as the terms are used herein, refer to, and includes, any and all conditions and/or states of the leased, rented, used, owned, transacted, service provided, and/or managed entity, including but not limited to loss, damage, interruption, deletion, disruption, corruption, theft, misappropriation, unauthorized copying, unauthorized access, unauthorized use, improper use, defacing, defaming, maligning, misrepresenting, wrongly portraying, impersonating, etc., malfunctioning and/or inoperable components and/or systems, state(s) of disrepair, and any and all other states and/or conditions which will subject the lessor and/or renter to any liability and/or loss therefor at the end of the lease, rental, usage, ownership, transaction, service providing, and/or management term.

Post-warranty, guaranty, service-level-agreement, and/or performance-assurance repairs and/or replacements, as the term is used herein, includes any and all repairs and/or replacements which are made necessary from any usage, creation, consumption, transaction, and/or storage, normal or otherwise, to components and/or systems of the herein-described entities and further includes repairs and/or replacements which result from defects in code, design, implementation, lifecycle management, supporting infrastructure, documentation, metadata, materials and/or workmanship. Post-warranty, guaranty, service-level-agreement, and/or performance-assurance repairs and/or replacements also include any and all repairs and/or replacements which would be covered under a developer's, designer's, service provider's, product supplier's, and/or manufacturer's warranty, guaranty, service-level-agreement, and/or performance-assurance. In this regard, the apparatus and method of the present invention provides for extended warranty, guaranty, service-level-agreement, and/or performance-assurance protection for the leased, rented, used, owned, transacted, service provided, and/or managed entity for the duration of the lease, rental, use, ownership, transaction, service providing, and/or management term. The database 7 also includes any and all data and/or information which will facilitate the calculation, determination and/or formulation of an exchange-of-risk-for-consideration agreement for providing, product, service and/or coverage for providing extended warranty, guaranty, service-level-agreement, and/or performance-assurance protection for any leased, rented, used, owned, transacted, service provided, and/or managed entity described herein.

The database 7 also includes data and/or information for particular individuals and/or entities which includes personal, individual and/or organizational usage patterns and/or usage histories and leasing, renting, using, owning, transacting, and/or management histories as well as any other information which an seller, originator, and/or broker of exchange-of-risk-for-consideration agreements may deem necessary and/or desirable in determining whether an exchange-of-risk-for-consideration agreement should be offered and/or underwritten for an individual and/or entity.

Data and/or information related to the leasing, renting, using, owning, transacting, and/or management of any other supporting and/or enabling assets, such as but not limited to, software, hardware, computing infrastructure, network infrastructure, network connections, professional services, and/or the providers, terms, contracting parties, and/or any other relevant supporting and/or enabling asset data and/or information (hereinafter referred to as “leasable, rentable, usable, able to be owned, able to be transacted, manageable article”), which may be the subject of a lease, rental, use, ownership, transaction, and/or management arrangement, is also included in the database 7.

Leasable, rentable, usable, able to be owned, able to be transacted, manageable article data and/or information includes article metadata, date of creation, creator, owner, licensor, licensee, terms of license, ownership history, termination history, transaction history, description, identifying codes and/or information, etc., article components and/or systems along with their replacement costs, repair and/or replacement costs, probability of damage, probability of post-warranty, guaranty, service-level-agreement, and/or performance-assurance repairs and/or replacements necessitated by usage, creation, consumption, transaction, and/or storage, damage, malfunctioning components and/or systems and defects in materials, parts, components, systems and/or workmanship, average costs for repairs and/or replacements, historical leasing, renting, using, owning, transacting, and/or management data and average total damage, deletion, corruption, unauthorized use, usage, creation, consumption, transaction, and/or storage, etc., of an improper nature costs for the entire article. Article leasing, renting, using, owning, transacting, and/or management data and/or information also includes locality, regional and geographical data which is correlated with damage, deletion, corruption, unauthorized use, usage, creation, consumption, transaction, and/or storage, etc., of an improper nature costs along with data and/or information which is related to usage habits and/or patterns in a given area or areas. Data and information related to individuals and/or entities, by region, occupation, use, technical attributes, service histories, financial histories, etc., including usage habits, leasing, renting, using, owning, transacting, and/or management histories, etc., will also be included in the database 7.

The database 7 also includes data and/or information for particular individuals and/or entities which includes personal, individual and/or organizational use and/or usage habits and/or patterns and/or use or usage histories and leasing, renting, using, owning, transacting, and/or management histories as well as any other information which an seller, originator, and/or broker of exchange-of-risk-for-consideration agreements may deem necessary and/or desirable in determining whether an exchange-of-risk-for-consideration agreement should be offered to an individual and/or entity.

Data and/or information related to the leasing, renting, using, owning, transacting, and/or management of online and/or digital environments, which is included in the database 7, includes type and age of the online and/or digital environments, portions and/or components and/or systems of the online and/or digital environments, along with their replacement costs, repair and/or replacement costs, probability of damage, probability of damage, probability of post-warranty, guaranty, service-level-agreement, and/or performance-assurance repairs and/or replacements necessitated by usage, creation, consumption, transaction, and/or storage, damage, malfunctioning components and/or systems and defects in materials, parts, components, systems and/or workmanship, average costs for repairs and/or replacements, historical leasing, renting, using, owning, transacting, and/or management information, average total usage, creation, consumption, transaction, and/or storage costs for the entire online and/or digital environments. Online and/or digital environments leasing, renting, using, owning, transacting, and/or management data and/or information also includes locality, regional and geographical data which is correlated with damage, deletion, corruption, unauthorized use, usage, creation, consumption, transaction, and/or storage, etc., of an improper nature, along with data and/or information which is related to use or usage habits and/or patterns for a given type of online and/or digital environments and/or for a given area or areas. Data and information related to individuals and/or entities, by region, nature of use or usage, including use or usage habits, leasing, renting, using, owning, transacting, and/or management histories, etc., is also included in the database 7.

The database 7 will also include data and/or information for particular individuals and/or entities which includes personal, individual and/or organizational use and/or usage habits and/or patterns and/or use or usage histories and leasing, renting, using, owning, transacting, and/or management histories as well as any other information which an seller, originator, and/or broker of exchange-of-risk-for-consideration agreements may deem necessary and/or desirable in determining whether an exchange-of-risk-for-consideration agreement should be offered to an individual and/or entity.

The data and/or information which is stored in the database(s) 7, in the preferred embodiment, also includes data and/or information related to various damage and/or repairs and/or replacements which may need to be performed for any of the above entities, the frequency with which these repairs and/or replacements had to be made in previous lease, rental, usage, ownership, transaction, service providing, and/or management situations involving the same, identical and/or similar types of individuals and/or entities, and the costs for repairing damage and/or needed repairs and/or replacements, which may include high, low and average repair and/or replacement costs. For example, if a motor digital asset, digital entity, and/or digital identity is leased, average, high and low repair and/or replacement costs which have resulted from previous leases of the same or a similar digital asset, digital entity, and/or digital identity, would be stored in the database 7, as would analogous information concerning any of the above identified leased, rented, used, owned, transacted, service provided, and/or managed entities and/or articles.

The database 7 also comprises any and all necessary actuarial, statistical, an exchange-of-risk-for-consideration, risk, risk of loss and application specific data and/or information which is related to, and which is necessary and/or helpful in calculating, determining, formulating and/or underwriting exchange-of-risk-for-consideration policies, products, services and/or coverage. In particular, the database 7 will contain any necessary and/or helpful data and/or information for providing exchange-of-risk-for-consideration policies, products, services and/or coverage for insuring against liability and/or loss for damage, deletion, corruption, unauthorized use, usage, creation, consumption, transaction, and/or storage, etc., of an improper nature to a leased and/or a rented entity which may occur during the lease, rental, usage, ownership, transaction, service providing, and/or management term, along with liability and/or loss for post-warranty, guaranty, service-level-agreement, and/or performance-assurance repairs and/or replacements.

The database 7 also comprises data and/or information related to an exchange-of-risk-for-consideration premiums which data and/or information is utilized to calculate and/or underwrite an exchange-of-risk-for-consideration agreement for providing, depending upon the nature and the amount of coverage for the leased, rented, used, owned, transacted, service provided, and/or managed entity of interest.

The database 7 also allows for the storing of data and/or information regarding the creation and/or development of digital assets/digital entities/digital identities, processing and/or fulfillment of operations related to digital assets/digital entities/digital identities, publication and/or management of digital assets/digital entities/digital identities, including all histories of usage, commercial terms, payments, technical, and/or communications usage in conjunction with the digital assets/digital entities/digital identities. This may include, but is not limited to, data and/or information regarding the user including all communications account information, financial account information, and a multitude of profiling information including, but not limited to, preferences, demographics, activity streams, behavioral targeting, data logging, digital footprint, lifelog, lifestreaming, profiling, runtime intelligence, social translucence, trace, trace evidence, genetic sequencing, psychographics, data represented in Attention Profiling Mark-up Language, subject and/or interest item information, communications, browsing histories, browsing patterns, documents, files, computational usage statistics, communications usage statistics, content created, content viewed, heard and/or read, content downloaded, applications used and/or downloaded, search queries, search results, click-through on search results, digital traces, activities, behaviors, login and logouts, visit of pages, documents accesses, items created, affiliation to groups, attention, social group, repetition, location, reputation, financial activities, investing activities, income data, spending data, consumption and/or presentation data, tax data, credit data, credit history data, reputational data, media related data, sensor discovered data, sensor recorded data, digital footprints, digital finger prints, life streams, social media linkages, social media activities, communications activities, computing activities, personal status, medical information, health information, personally identifiable information, volunteered information, collected information, rumored information, non-volunteered information, information capable of being stored in log files, information capable of being stored locally and/or or in a private and/or public cloud computing environment, information capable of being stored in databases, mined data, as well as analytics associated with the aforementioned data and/or information, for individuals and/or entities which information can be utilized in an exchange-of-risk-for-consideration agreement and/or premium determinations and calculations. The database 7 also comprises data and/or information concerning past lease, rental, use, ownership, transaction, service providing, and/or management experiences, if any, for individuals and entities, including specific individuals and/or entities, along with corresponding records concerning any end of lease, rental, use, ownership, transaction, service providing, and/or management damage and/or usage, creation, consumption, transaction, and/or storage which may have occurred in past leasing, renting, using, owning, transacting, and/or management relationships.

The database 7 also contains data and/or information related to leasing, renting, using, owning, transacting, and/or management term, data and/or information related to geography, season, etc., along with data and/or information related to how these variables affect any other data and/or information described herein.

The database 7 also contains data and/or information related to leasing, renting, using, owning, transacting, and/or management term, data and/or information related to digital currencies, units of economic value/monetary value/actual currencies and/or monetary units stored in online and/or digital accounts, which are invested saved, wagered, used, stored/transacted in online and/or digital accounts and/or transactions, etc., along with data and/or information related to how these variables affect any other data and/or information described herein.

The data and/or information which is stored in the database 7, in addition to the above data and/or information, contains any other necessary, recommended and/or supplemental data and/or information, and/or application program(s) which may be helpful and/or desired by an seller, originator, and/or broker of exchange-of-risk-for-consideration agreements in determining whether to issue an exchange-of-risk-for-consideration agreement for providing, product, service and/or coverage described herein.

The data and/or information which is stored in the database 7 may be utilized to calculate risk, risk of loss and/or damage probabilities for an individual and/or entity, for any given lease, rental, use, ownership, transaction, service providing, and/or management situation, lease, rental, use, ownership, transaction, service providing, and/or management entity and/or lease, rental, usage, ownership, transaction, service providing, and/or management agreement.

The data and/or information which is stored in the database 7 may be utilized to calculate risk, risk of loss and/or damage probabilities for any of the leased, rented, used, owned, transacted, service provided, and/or managed digital assets, digital entities, and/or digital identities, articles and/or online and/or digital environments described herein, for any individual and/or entity and for any given lease, rental, usage, ownership, transaction, service providing, and/or management situation. The present invention may be utilized to custom design and/or calculate an exchange-of-risk-for-consideration agreement for providing, product, service and/or coverage for a particular lease, rental, use, ownership, transaction, service providing, and/or management agreement and/or situation by utilizing risk, risk of loss, risk assessment and underwriting techniques which can be modified for the particular application.

The data and/or information described herein will be utilized to generate and underwrite an exchange-of-risk-for-consideration agreement for providing as well as to calculate an exchange-of-risk-for-consideration premium or charges, depending upon the nature and the amount of the coverage desired for the leased, rented, used, owned, transacted, service provided, and/or managed entity. The data and/or information which is stored in the database 7 will be updated regularly so as to maintain the most accurate and current data as possible. The database 7 can also contain any data and/or information needed and/or desired for creating and pricing a derivative credit products and/or services or derivative credit products and/or services which can be utilized in order to allow a respective an exchange-of-risk-for-consideration company, seller, originator, and/or broker of exchange-of-risk-for-consideration agreements, or other issuer, of any of the lease, rental, use, ownership, transaction, service providing, and/or management exchange-of-risk-for-consideration policies or lease, rental, use, ownership, transaction, service providing, and/or management exchange-of-risk-for-consideration products described herein, to off-set of the risk associated with its liability and/or loss or risk of loss, to limit its liability and/or loss or risk of loss, and/or to obtain an exchange-of-risk-for-consideration or an exchange-of-risk-for-consideration, for any liability and/or loss or liabilities and/or potential liability and/or loss or potential liabilities which may be associated with and/or which may result from the issuance of any of the herein-described lease, rental, use, ownership, transaction, service providing, and/or management exchange-of-risk-for-consideration policies or lease, rental, use, ownership, transaction, service providing, and/or management exchange-of-risk-for-consideration products.

The present invention provides an apparatus and a method for providing exchange-of-risk-for-consideration policies, products, services and/or any of the herein-described coverage for any of the herein-described leased, rented, used, owned, transacted, service provided, and/or managed entities. In this regard, individuals and/or entities may obtain an exchange-of-risk-for-consideration so as to protect themselves from liabilities which might arise from a leased, rented, used, owned, transacted, service provided, and/or managed entity being returned with damage and/or usage, creation, consumption, transaction, and/or storage at the end of the lease, rental, usage, ownership, transaction, service providing, and/or management term, as well as providing protection against liabilities for post-warranty, guaranty, service-level-agreement, and/or performance-assurance repairs and/or replacements.

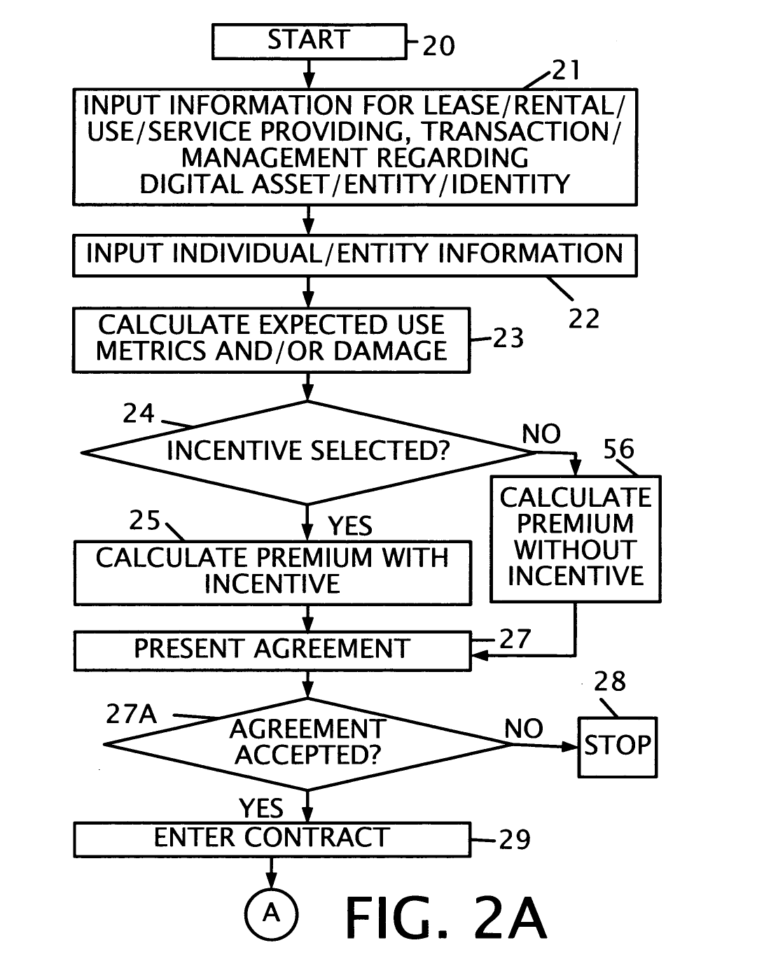

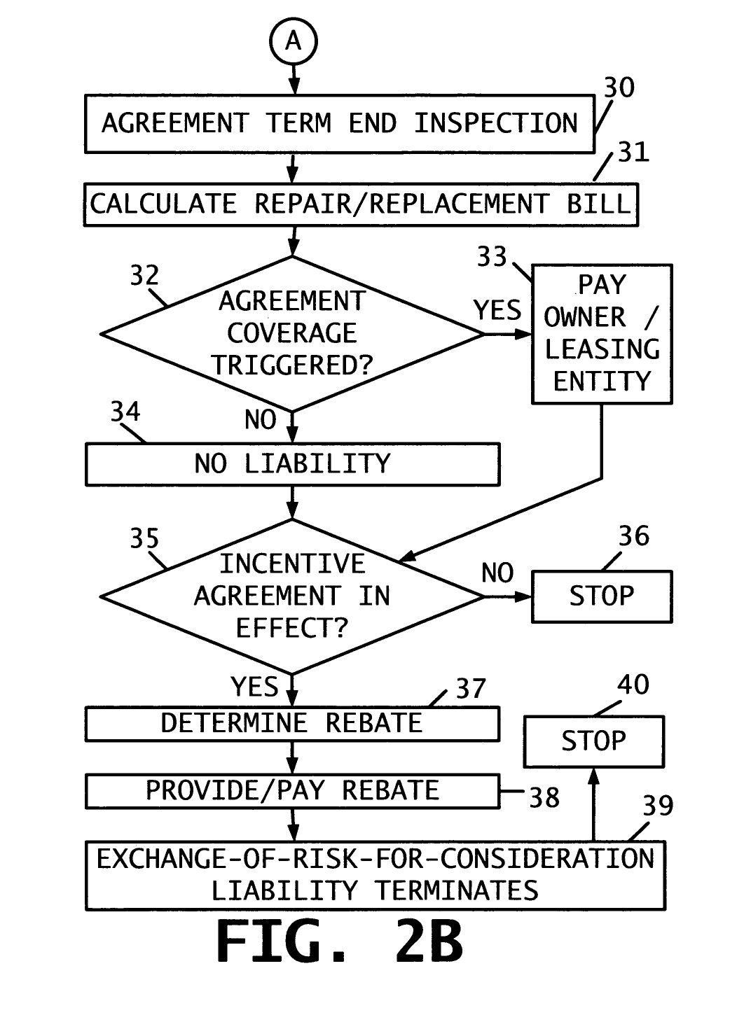

FIGS. 2A and 2B illustrate a flow diagram of a preferred embodiment method of operation of, or method for utilizing, the apparatus and method of the present invention which is utilized in conjunction with leased, rented, used, owned, transacted, service provided, and/or managed digital assets, digital entities, digital identities, digital currencies, applications, applets, digital audio, digital video, digital text, data, information, algorithms, programs, online stores, virtual worlds, avatars, virtual characters, electronic books, video files, e-magazines, e-tickets, e-documents, chat rooms, internet forums, virtual communities, virtual artifacts, virtual weapons, virtual tools, digital currencies, units of economic value/monetary value/actual currencies and/or monetary units stored in online and/or digital accounts, which are invested saved, wagered, used, stored/transacted in online and/or digital accounts and/or transactions, computational processes, commands, and/or programs, etc., which exist in games, and/or gaming, and/or entertainment, and/or education, and/or business, and/or as elements of other forms of utility in digital environments which may be assets in commerce, entertainment, gaming, music, video, and the like, which constitute an asset, and/or class of assets, in digital form, which also includes the online and/or digital environments themselves.

In FIGS. 2A and 2B, the method and/or operation of the apparatus commences at step 20. At step 21, data and/or information pertaining to the digital asset, digital entity, and/or digital identity to be leased, rented, used, owned, transacted, service provided, and/or managed, including, along with the lease, rental, use, ownership, transaction, service providing, and/or management term and any other pertinent information related to the lease, rental, use, ownership, transaction, service providing, and/or management will be selected and input into the apparatus 100. Information pertaining to an exchange-of-risk-for-consideration coverage for post-warranty, guaranty, service-level-agreement, and/or performance-assurance repairs and/or replacements, if desired, is also selected and input at step 21.

At step 22, data and/or information related to the individual or entity who or which, respectively, will be leasing, renting, using, owning, transacting, and/or management the digital asset, digital entity, and/or digital identity (e.g. individual, entity, including usage history, an exchange-of-risk-for-consideration history, past leasing, renting, using, owning, transacting, and/or management history, desired an exchange-of-risk-for-consideration coverage, an exchange-of-risk-for-consideration deductible, an exchange-of-risk-for-consideration agreement for providing terms, etc.) will be entered into the apparatus 100. At step 22, the individual and/or entity may or may not also select an exchange-of-risk-for-consideration agreement for providing which provides for an incentive for maintaining the digital asset, digital entity, and/or digital identity with no and/or minimum usage, creation, consumption, transaction, and/or storage and/or with no and/or minimum damage during the lease, rental, use, ownership, transaction, service providing, and/or management term. In this regard, the individual and/or entity may select to participate in an incentive agreement whereby the individual and/or entity may receive a rebate and/or a return of a portion of the consideration paid on an exchange-of-risk-for-consideration agreement at the end of the lease, rental, use, ownership, transaction, service providing, and/or management term if the digital asset, digital entity, and/or digital identity is returned with no and/or minimal damage, deletion, corruption, unauthorized use, usage, creation, consumption, transaction, and/or storage, etc., of an improper nature.

At step 23, the apparatus 100 will calculate expected damage, deletion, corruption, unauthorized use, usage, creation, consumption, transaction, and/or storage, etc., of an improper nature, and/or information related to post-warranty, guaranty, service-level-agreement, and/or performance-assurance repair, which is expected to occur during the lease, rental, use, ownership, transaction, service providing, and/or management term, given the data input at steps 21 and 22 along with the pertinent data and/or information which is stored in the database 7. The data and/or information which is stored in the database 7 and which is utilized in calculating an exchange-of-risk-for-consideration premium and formulating the associated an exchange-of-risk-for-consideration agreement for providing may also include any one or more of data and/or information related to various damage and/or repairs and/or replacements which may need to be performed on, or for, the digital asset, digital entity, and/or digital identity in question, the frequency with which these repairs and/or replacements had to be made in previous leases, rentals, uses, services, transactions, and/or management dealing with the same, identical and/or similar and/or analogous digital asset, digital entity, and/or digital identities, the costs for repairing excessive damage, deletion, corruption, unauthorized use, usage, creation, consumption, transaction, and/or storage, etc., of an improper nature, post-warranty, guaranty, service-level-agreement, and/or performance-assurance repair data, data and/or information related to an exchange-of-risk-for-consideration premiums which data and/or information is utilized to calculate an associated an exchange-of-risk-for-consideration premium, the nature of the desired coverage, coverage deductibles, statistical information related to any of the above data and/or information as well as statistical information and/or demographic information, and usage record histories for the individual and/or entity as well as for individuals and/or entities in the same, similar or analogous classes.

Database data and/or information also includes past lease, rental, use, ownership, transaction, service providing, and/or management experiences, if any, for the individual and/or entity as well as for individuals and/or entities in the same, similar, or analogous classes, records concerning any end of lease, rental, use, ownership, transaction, service providing, and/or management damage which may have occurred in an individual's and/or entity's past leasing, renting, using, owning, transacting, and/or management relationships, or for those individuals and/or entities in the same, similar or analogous classes and data and/or information related to lease, rental, usage, ownership, transaction, service providing, and/or management term.

At step 24, the apparatus 100 will determine whether the individual and/or entity has chosen to participate in an exchange-of-risk-for-consideration agreement for providing which provides for the above-described incentives. At step 24, if an incentive agreement for providing has been chosen, the apparatus 100, at step 25, will calculate or formulate an exchange-of-risk-for-consideration agreement and corresponding premium or charge which provides for the above-described incentive feature. If, at step 24, it is determined that an incentive agreement for providing has not been chosen, the apparatus 100, at step 26, will calculate or formulate an exchange-of-risk-for-consideration agreement and corresponding premium without the incentive feature.

At step 27, an agreement for providing can then be presented to the individual and/or entity for acceptance. The individual may then, at step 27, chose to accept or reject an exchange-of-risk-for-consideration agreement. If, at step 27A, it is determined that the individual and/or entity did not accept an exchange-of-risk-for-consideration agreement, the processing will cease at step 28. If, at step 27A, it is determined that the individual and/or entity accepted an exchange-of-risk-for-consideration agreement, the parties will enter into the relevant exchange-of-risk-for-consideration contract at step 29, typically with the payment of the consideration or partial payment of the consideration and the issuance of an exchange-of-risk-for-consideration agreement. An exchange-of-risk-for-consideration agreement will thereafter be issued. An exchange-of-risk-for-consideration agreement will thereafter be in effect so as to protect the individual and/or entity from liability and/or loss for damage, deletion, corruption, unauthorized use, usage, creation, consumption, transaction, and/or storage, etc., of an improper nature which may occur to the digital asset, digital entity, and/or digital identity during the lease, rental, use, ownership, transaction, service providing, and/or management term. Upon the termination of the lease, rental, use, ownership, transaction, service providing, and/or management term, at step 30, the digital asset, digital entity, and/or digital identity will be inspected for damage, deletion, corruption, unauthorized use, usage, creation, consumption, transaction, and/or storage, etc., of an improper nature.

At step 31, the value or repair amount and/or liability and/or loss for any damage, deletion, corruption, unauthorized use, usage, creation, consumption, transaction, and/or storage, etc., of an improper nature, which may be found, will be calculated. If post-warranty, guaranty, service-level-agreement, and/or performance-assurance coverage is in effect, the value for any post-warranty, guaranty, service-level-agreement, and/or performance-assurance repairs and/or replacements will also be determined at step 31. At step 32, the apparatus 100 will then determine if the value of any damage, deletion, corruption, unauthorized use, usage, creation, consumption, transaction, and/or storage, etc., of an improper nature is of such a magnitude to trigger an agreement for providing coverage. The apparatus 100 will also, at step 32, determine if post-warranty, guaranty, service-level-agreement, and/or performance-assurance coverage is triggered.

If, at step 32, an agreement for providing coverage is triggered, an exchange-of-risk-for-consideration provider or an underwriter will, at step 33, assume responsibility for, and effect payment to the digital asset, digital entity, and/or digital identity owner and/or leasing, renting, using, owning, transacting, and/or management entity for, the damage, deletion, corruption, unauthorized use, usage, creation, consumption, transaction, and/or storage, etc., of an improper nature. An exchange-of-risk-for-consideration provider or an underwriter will also, at step 33, assume responsibility for, and effect payment for any post-warranty, guaranty, service-level-agreement, and/or performance-assurance repairs and/or replacements, if such coverage is in effect. If, however, coverage is not triggered at step 32, an exchange-of-risk-for-consideration provider or underwriter will, at step 34, have no liability and/or loss to the digital asset, digital entity, and/or digital identity owner or leasing, renting, using, owning, transacting, and/or management entity.

At step 35, it will be determined if an incentive agreement for providing is in effect. If no incentive an agreement for providing is in effect, the operation of the apparatus and/or process will cease at step 36. If, at step 35, it is determined that an incentive agreement for providing is in effect, the apparatus 100, at step 37, will determine the amount of the rebate and/or premium which is to be returned to the individual and/or entity. At step 38, the individual and/or entity will receive the rebate.

If no usage, creation, consumption, transaction, and/or storage and/or no damage has been found to exist, the individual and/or entity will receive the full rebate amount at step 38. If damage, deletion, corruption, unauthorized use, usage, creation, consumption, transaction, and/or storage, etc., of an improper nature has been found to exist at, or above, a pre-defined amount, the individual and/or entity will receive no rebate at step 38. If damage, deletion, corruption, unauthorized use, usage, creation, consumption, transaction, and/or storage, etc., of an improper nature has been found to exist below a pre-defined limit, a rebate amount will be calculated according to a pre-defined calculation and/or interpolation routine and the individual and/or entity will receive the calculated amount at step 38.

In the preferred embodiment, a linear interpolation routine is utilized to calculate the partial rebate amount at step 38. It is important to note that any mathematical computation routine and/or interpolation routine, linear or non-linear, as well as any other method for calculating an amount, or a partial amount, may be utilized in the processing scheme of the present invention. As noted above, rebate calculations will be performed at step 37.

Once the individual and/or entity has been issued their or its rebate, the liability and/or loss of an exchange-of-risk-for-consideration provider and/or underwriter will cease at step 39. The operation and method of the present invention will then cease at step 40.

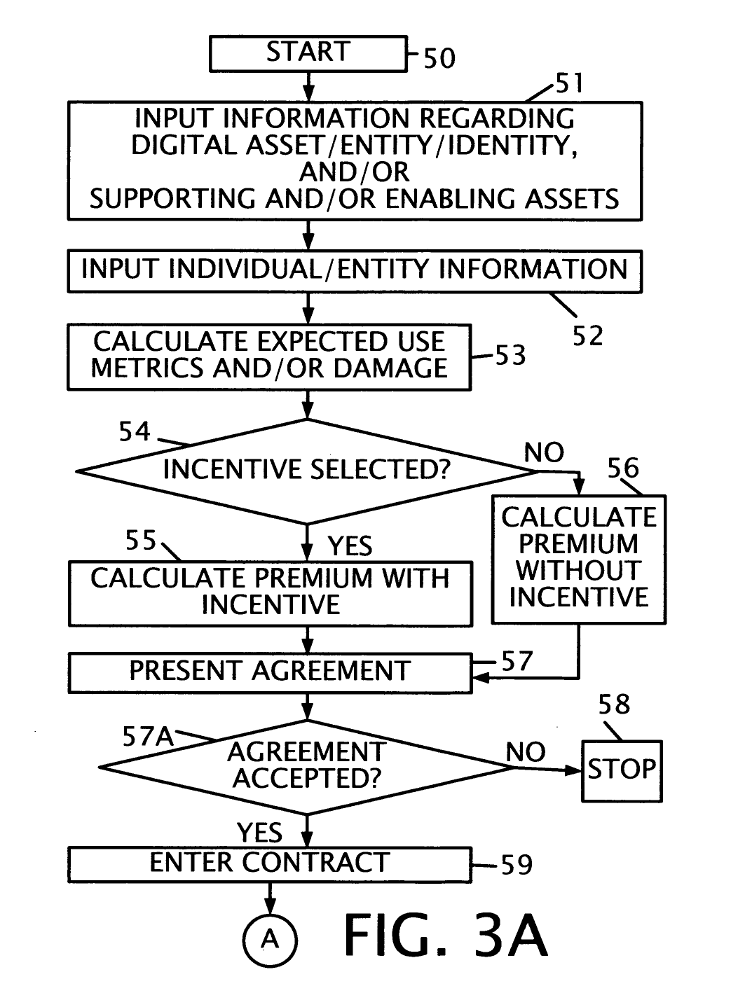

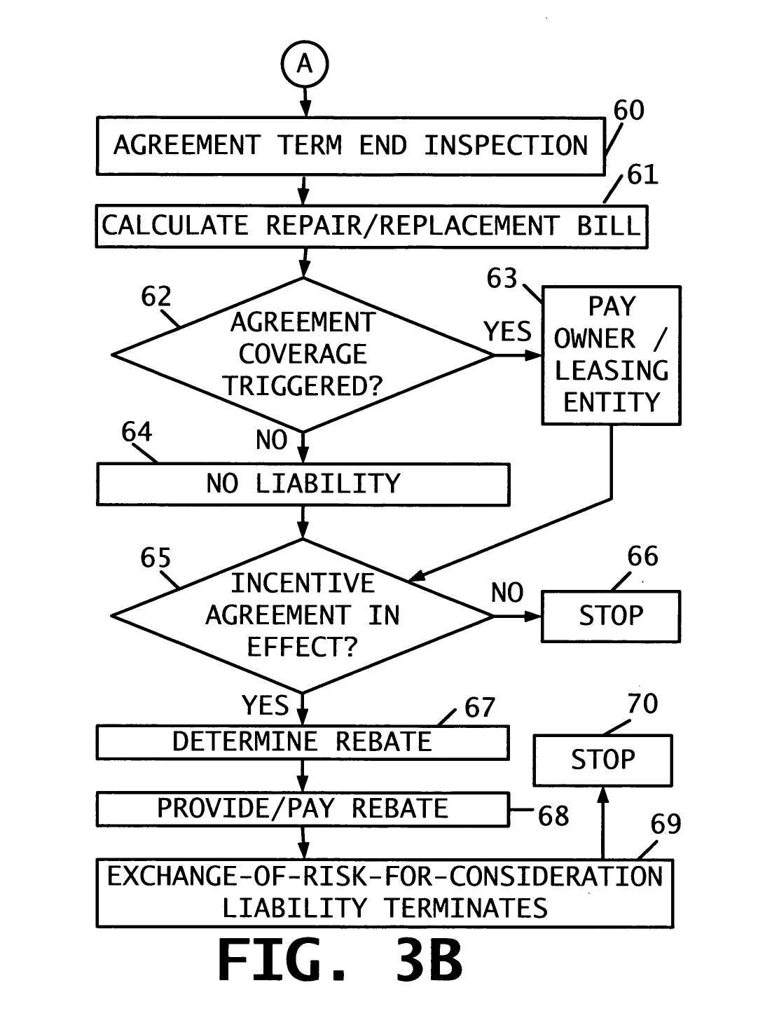

FIGS. 3A and 3B illustrate a flow diagram of another embodiment method of operation of, or method for utilizing, the apparatus and method of the present invention which is utilized in conjunction with a leased, rented, used, owned, transacted, and/or managed article, which may include any other supporting and/or enabling assets, such as but not limited to, software, hardware, computing infrastructure, network infrastructure, network connections, professional services, and/or the providers, terms, contracting parties, and/or any other relevant supporting and/or enabling asset data and/or information, and any other item, device or article which may be deemed to be desirable as the subject of a lease, rental, use, ownership, transaction, service providing, and/or management arrangement and/or agreement (hereinafter referred to as “article”).

In FIGS. 3A and 3B, the operation of the apparatus and method commences at step 50. At step 51, data and/or information pertaining to the article to be leased, rented, used, owned, transacted, service provided, and/or managed, including, along with the lease, rental, use, ownership, transaction, service providing, and/or management term and any other pertinent information related to the lease, rental, use, ownership, transaction, service providing, and/or management (e.g. use allowance, down payment, security payment, lease, rental, use, ownership, transaction, service providing, and/or management end purchase option and price, etc.) will be selected and input into the apparatus 100. Information pertaining to an exchange-of-risk-for-consideration coverage for post-warranty, guaranty, service-level-agreement, and/or performance-assurance repairs and/or replacements, if desired, is also selected and input at step 51.

At step 52, data and/or information related to the individual and/or entity who, or which, respectively, will be leasing, renting, using, owning, transacting, and/or management the article, (e.g. individual and/or entity use or usage history, an exchange-of-risk-for-consideration history, past leasing, renting, using, owning, transacting, and/or management history, desired an exchange-of-risk-for-consideration coverage, an exchange-of-risk-for-consideration deductible, an exchange-of-risk-for-consideration agreement for providing terms, etc.) will be entered into the apparatus 100. At step 52, the individual and/or entity may or may not also select an exchange-of-risk-for-consideration agreement for providing which provides for an incentive for maintaining the article with no and/or minimum usage, creation, consumption, transaction, and/or storage and/or with no and/or minimum damage during the lease, rental, use, ownership, transaction, service providing, and/or management term. In this regard, the individual and/or entity may select to participate in an incentive agreement whereby the individual and/or entity may receive a rebate and/or a return of a portion of the consideration paid on an exchange-of-risk-for-consideration agreement at the end of the lease, rental, use, ownership, transaction, service providing, and/or management term if the article is returned with no and/or minimal damage, deletion, corruption, unauthorized use, usage, creation, consumption, transaction, and/or storage, etc., of an improper nature.

At step 53, the apparatus 100 will calculate expected damage, deletion, corruption, unauthorized use, usage, creation, consumption, transaction, and/or storage, etc., of an improper nature, and/or information related to post-warranty, guaranty, service-level-agreement, and/or performance-assurance repair, which is expected to occur during the lease, rental, use, ownership, transaction, service providing, and/or management term, given the data input at steps 51 and 52 along with the pertinent data and/or information which is stored in the database 7. The data and/or information which is stored in the database 7 and which is utilized in calculating an exchange-of-risk-for-consideration premium and formulating the associated an exchange-of-risk-for-consideration agreement for providing may also include any one or more of data and/or information related to various damage and/or repairs and/or replacements which may need to be performed on the article in question, the frequency with which these repairs and/or replacements had to be made in previous leases, rentals, uses, services, transactions, and/or management dealing with the same, identical and/or similar and/or analogous articles, the costs for repairing excessive damage, deletion, corruption, unauthorized use, usage, creation, consumption, transaction, and/or storage, etc., of an improper nature, post-warranty, guaranty, service-level-agreement, and/or performance-assurance repair data, data and/or information related to an exchange-of-risk-for-consideration premiums which data and/or information is utilized to calculate an associated an exchange-of-risk-for-consideration premium, the nature of the desired coverage, coverage deductibles, statistical information related to any of the above data and/or information as well as statistical information related to sex, age and use and/or usage histories for the individual and/or entity as well as for individuals and/or entities in the same, similar or analogous classes.

Database data and/or information also includes past lease, rental, use, ownership, transaction, service providing, and/or management experiences, if any, for the individual and/or entity as well as for individuals and/or entities in the same, similar, or analogous classes, records concerning any end of lease, rental, use, ownership, transaction, service providing, and/or management damage which may have occurred in an individual's and/or entity's past leasing, renting, using, owning, transacting, and/or management relationships, or for those individuals and/or entities in the same, similar or analogous classes and data and/or information related to lease, rental, usage, ownership, transaction, service providing, and/or management term.

At step 54, the apparatus 100 will determine whether the individual and/or entity has chosen to participate in an exchange-of-risk-for-consideration agreement for providing which provides for the above-described incentives. At step 54, if an incentive agreement for providing has been chosen, the apparatus 100 will, at step 55, calculate or formulate an exchange-of-risk-for-consideration agreement and corresponding premium or charge which provides for the above-described incentive feature. If, at step 54, it is determined that an incentive agreement for providing has not been chosen, the apparatus 100, at step 56, will calculate or formulate an exchange-of-risk-for-consideration agreement and corresponding premium without the incentive feature.

At step 57, an agreement for providing can then be presented to the individual and/or entity for acceptance. The individual may then, at step 57, accept or reject an exchange-of-risk-for-consideration agreement. If, at step 57A, it is determined that the individual and/or entity did not accept an exchange-of-risk-for-consideration agreement, the processing will cease at step 58. If, at step 57A, it is determined that the individual and/or entity accepted an exchange-of-risk-for-consideration agreement, the parties will enter into the relevant exchange-of-risk-for-consideration contract at step 59, typically with the payment of the consideration or partial payment of the consideration and the issuance of an exchange-of-risk-for-consideration agreement. An exchange-of-risk-for-consideration agreement will then be issued. An exchange-of-risk-for-consideration agreement will thereafter be in effect so as to protect the individual and/or entity from liability and/or loss for damage, deletion, corruption, unauthorized use, usage, creation, consumption, transaction, and/or storage, etc., of an improper nature which may occur to the digital asset, digital entity, and/or digital identity during the lease, rental, use, ownership, transaction, service providing, and/or management term. Upon the termination of the lease, rental, use, ownership, transaction, service providing, and/or management period, at step 60, the article will be inspected for damage, deletion, corruption, unauthorized use, usage, creation, consumption, transaction, and/or storage, etc., of an improper nature.

At step 61, the value or repair amount and/or liability and/or loss for any damage, deletion, corruption, unauthorized use, usage, creation, consumption, transaction, and/or storage, etc., of an improper nature which may be found, will be calculated. If post-warranty, guaranty, service-level-agreement, and/or performance-assurance coverage is in effect, the value for any post-warranty, guaranty, service-level-agreement, and/or performance-assurance repairs and/or replacements will also be determined at step 61. At step 62, the apparatus 100 will then determine if the value of any damage, deletion, corruption, unauthorized use, usage, creation, consumption, transaction, and/or storage, etc., of an improper nature is of such a magnitude to trigger an agreement for providing coverage. The apparatus 100 will also, at step 62, determine if post-warranty, guaranty, service-level-agreement, and/or performance-assurance coverage is triggered.

If, at step 62, an agreement for providing coverage is triggered, an exchange-of-risk-for-consideration provider or an underwriter will, at step 63, assume responsibility for, and effect payment to the article owner and/or leasing, renting, using, owning, transacting, and/or management entity for, the damage, deletion, corruption, unauthorized use, usage, creation, consumption, transaction, and/or storage, etc., of an improper nature. An exchange-of-risk-for-consideration provider or an underwriter will also, at step 63, assume responsibility for, and effect payment for any post-warranty, guaranty, service-level-agreement, and/or performance-assurance repairs and/or replacements, if such coverage is in effect. If, however, coverage is not triggered at step 62, an exchange-of-risk-for-consideration provider or underwriter will, at step 64, have no liability and/or loss to the article owner or leasing, renting, using, owning, transacting, and/or management entity.

At step 65, it will be determined if an incentive agreement for providing is in effect. If no incentive an agreement for providing is in effect, the operation of the apparatus and/or process will cease at step 66. If, at step 55, it is determined that an incentive agreement for providing is in effect, the apparatus 100 will, at step 67, determine the amount of the rebate and/or returned premium which is to be returned to the individual and/or entity. At step 68, the individual and/or entity will receive the rebate.

If no usage, creation, consumption, transaction, and/or storage and/or no damage has been found to exist, the individual and/or entity will receive the full rebate amount at step 68. If damage, deletion, corruption, unauthorized use, usage, creation, consumption, transaction, and/or storage, etc., of an improper nature has been found to exist at, or above, a pre-defined amount, the individual and/or entity will receive no rebate at step 68. If damage, deletion, corruption, unauthorized use, usage, creation, consumption, transaction, and/or storage, etc., of an improper nature has been found to exist below a pre-defined limit, a rebate amount will be calculated according to a pre-defined calculation and/or interpolation routine and the individual and/or entity will receive the calculated amount at step 68.

In the preferred embodiment, a linear interpolation routine is utilized to calculate the partial rebate amount at step 68. It is important to note that any mathematical computation routine and/or interpolation routine, linear or non-linear, as well as any other method for calculating an amount or a partial amount, may be utilized in the processing scheme of the present invention. As noted above, rebate calculations will be performed during step 67.

Once the individual and/or entity has been issued their or its rebate, the liability and/or loss of an exchange-of-risk-for-consideration provider and/or underwriter will cease at step 69. The operation and method of the present invention will then cease at step 70.

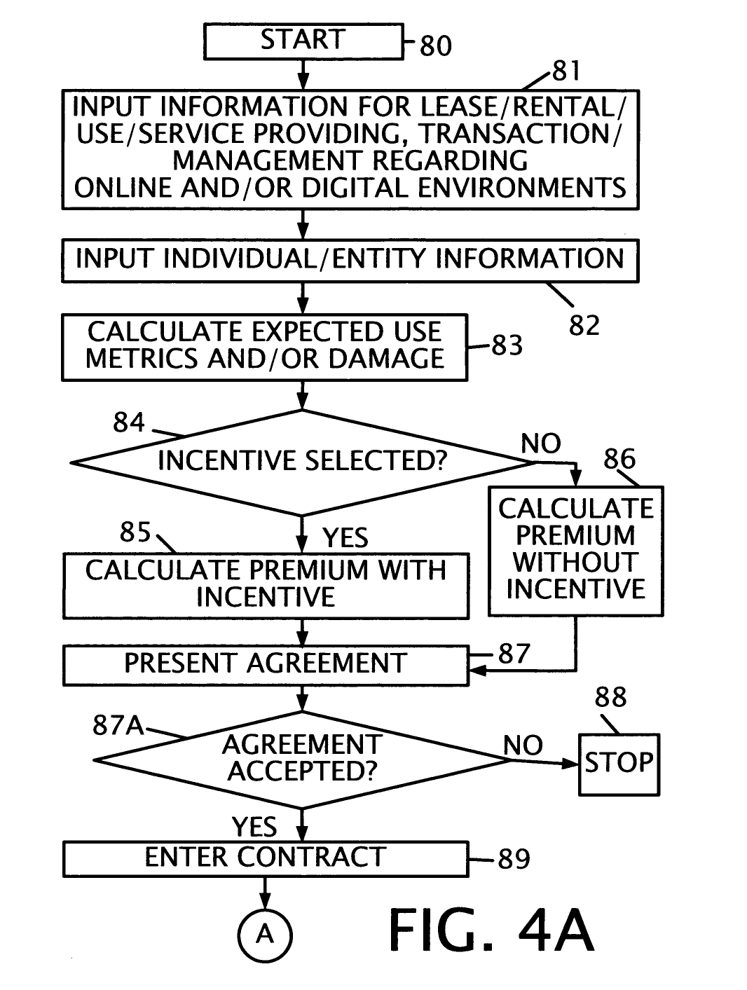

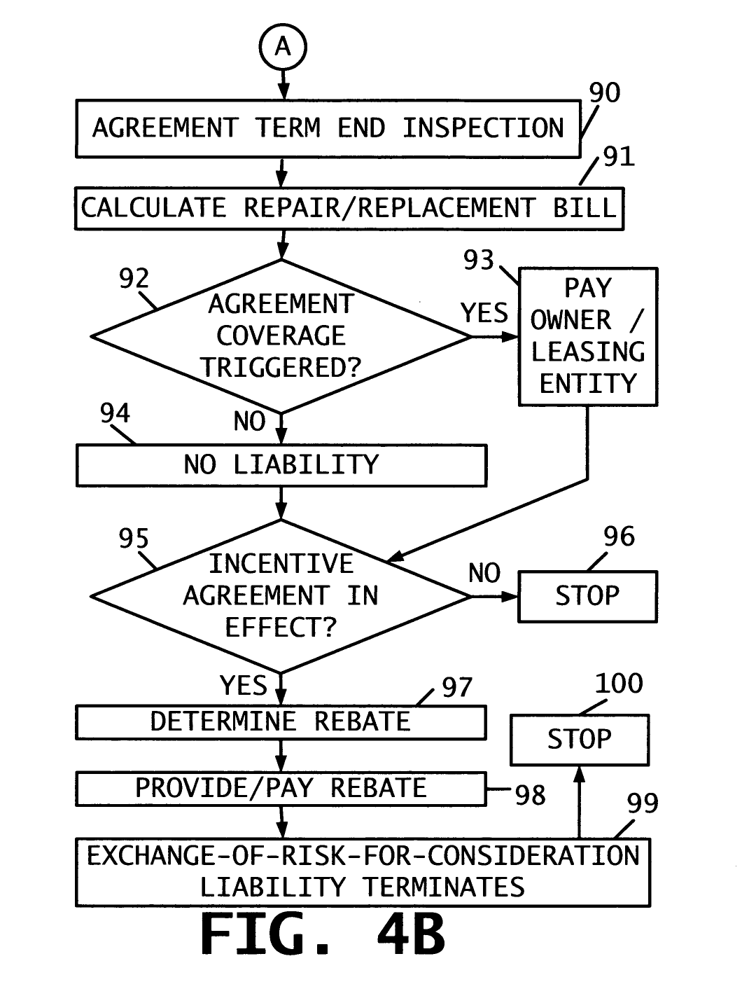

FIGS. 4A and 4B illustrate a flow diagram of another embodiment method of operation of, or method for utilizing, the apparatus and method of the present invention which is utilized in conjunction with a leased, rented, used, owned, transacted, service provided, and/or managed online and/or digital environments (hereinafter referred to as “online and/or digital environments”).

In FIGS. 4A and 4B, the operation of the apparatus and/or method commences at step 80. At step 81, data and/or information pertaining to the type, age, make and model, along with lease, rental, use, ownership, transaction, service providing, and/or management term, and any other pertinent information related to the lease, rental, use, ownership, transaction, service providing, and/or management (e.g. use allowance, down payment, security payment, lease end purchase option and price, etc.) to be leased will be selected and input into the apparatus 100. Information pertaining to an exchange-of-risk-for-consideration coverage for post-warranty, guaranty, service-level-agreement, and/or performance-assurance repairs and/or replacements, if desired, is also selected and input at step 81.

At step 82, data and/or information related to the individual or entity who or which, respectively, will be leasing, renting, using, owning, transacting, and/or management the online and/or digital environments (e.g. individual and/or entity use or usage history, an exchange-of-risk-for-consideration history, past leasing, renting, using, owning, transacting, and/or management history, desired an exchange-of-risk-for-consideration coverage, an exchange-of-risk-for-consideration deductible, an exchange-of-risk-for-consideration agreement for providing terms, etc.) will be entered into the apparatus 100. At step 82, the individual and/or entity may or may not also select an exchange-of-risk-for-consideration agreement for providing which provides for an incentive for maintaining the online and/or digital environments with no and/or minimum usage, creation, consumption, transaction, and/or storage and/or with no and/or minimum damage during the lease, rental, use, ownership, transaction, service providing, and/or management term. In this regard, the individual and/or entity may select to participate in an incentive agreement whereby the individual and/or entity can receive a rebate and/or a return of a portion of the consideration paid on an exchange-of-risk-for-consideration agreement at the end of the lease, rental, use, ownership, transaction, service providing, and/or management term if the online and/or digital environments is returned with no and/or minimal damage, deletion, corruption, unauthorized use, usage, creation, consumption, transaction, and/or storage, etc., of an improper nature.

At step 83, the apparatus 100 will calculate expected damage, deletion, corruption, unauthorized use, usage, creation, consumption, transaction, and/or storage, etc., of an improper nature, and/or information related to post-warranty, guaranty, service-level-agreement, and/or performance-assurance repair, which is expected to occur during the lease, rental, use, ownership, transaction, service providing, and/or management term, given the data input at steps 81 and 82 along with the pertinent data and/or information which is stored in the database 7. The data and/or information which is stored in the database 7 and which is utilized in calculating an exchange-of-risk-for-consideration premium and formulating the associated an exchange-of-risk-for-consideration agreement for providing may also include any one or more of data and/or information related to various damage and/or repairs and/or replacements which may need to be performed on, or for, the online and/or digital environments in question, the frequency with which these repairs and/or replacements had to be made in previous leases, rentals, uses, services, transactions, and/or management dealing with the same, identical and/or similar and/or analogous online and/or digital environments, the costs for repairing excessive damage, deletion, corruption, unauthorized use, usage, creation, consumption, transaction, and/or storage, etc., of an improper nature, post-warranty, guaranty, service-level-agreement, and/or performance-assurance repair data, data and/or information related to an exchange-of-risk-for-consideration premiums which data and/or information is utilized to calculate an associated an exchange-of-risk-for-consideration premium, the nature of the desired coverage, coverage deductibles, statistical information related to any of the above data and/or information as well as statistical information related to sex, age and use and usage histories for the individual and/or entity as well as for individuals and/or entities in the same, similar or analogous classes.

Database data and/or information also includes past lease, rental, use, ownership, transaction, service providing, and/or management experiences, if any, for the individual or entity as well as for individuals and/or entities in the same, similar or analogous classes, records concerning any end of lease, rental, use, ownership, transaction, service providing, and/or management damage which may have occurred in an individual's and/or entity's past leasing, renting, using, owning, transacting, and/or management relationships, or for those individuals and/or entities in the same, similar or analogous classes and data and/or information related to lease, rental, usage, ownership, transaction, service providing, and/or management term.

At step 84, the apparatus 100 will determine whether the individual and/or entity has chosen to participate in an exchange-of-risk-for-consideration agreement for providing which provides for the above-described incentives. At step 84, if an incentive agreement for providing has been chosen, the apparatus 100, at step 85, will calculate or formulate an exchange-of-risk-for-consideration agreement and corresponding premium or charge which provides for the above-described incentive feature. If, at step 84, it is determined that an incentive agreement for providing has not been chosen, the apparatus 100, at step 86, will calculate or formulate an exchange-of-risk-for-consideration agreement and corresponding premium without the incentive feature.

At step 87, an agreement for providing can then be presented to the individual and/or entity for acceptance. The individual may then, at step 87, accept or reject an exchange-of-risk-for-consideration agreement. If, at step 87A, it is determined that the individual and/or entity-did not accept an exchange-of-risk-for-consideration agreement, the processing will cease at step 88. If, at step 87A, it is determined that the individual and/or entity accepted an exchange-of-risk-for-consideration agreement, the parties will enter into the relevant exchange-of-risk-for-consideration contract at step 89, typically with the payment of the consideration or partial payment of the consideration and the issuance of an exchange-of-risk-for-consideration agreement. An exchange-of-risk-for-consideration agreement will then be issued. An exchange-of-risk-for-consideration agreement will thereafter be in effect so as to protect the individual and/or entity from liability and/or loss for damage, deletion, corruption, unauthorized use, usage, creation, consumption, transaction, and/or storage, etc., of an improper nature which may occur to the online and/or digital environments during the lease, rental, use, ownership, transaction, service providing, and/or management term. Upon the termination of the lease, rental, use, ownership, transaction, service providing, and/or management period, at step 90, the online and/or digital environments will be inspected for damage, deletion, corruption, unauthorized use, usage, creation, consumption, transaction, and/or storage, etc., of an improper nature.

At step 91, the value or repair amount and/or liability and/or loss for any damage, deletion, corruption, unauthorized use, usage, creation, consumption, transaction, and/or storage, etc., of an improper nature which may be found, will be calculated. If post-warranty, guaranty, service-level-agreement, and/or performance-assurance coverage is in effect, the value for any post-warranty, guaranty, service-level-agreement, and/or performance-assurance repairs and/or replacements will also be determined at step 91. At step 92, the apparatus 100 will then determine if the value of any damage, deletion, corruption, unauthorized use, usage, creation, consumption, transaction, and/or storage, etc., of an improper nature is of such a magnitude to trigger an agreement for providing coverage. The apparatus 100 will also, at step 92, determine if post-warranty, guaranty, service-level-agreement, and/or performance-assurance coverage is triggered.

If, at step 92, coverage is triggered, an exchange-of-risk-for-consideration provider or an underwriter will, at step 93, assume responsibility for, and effect payment to the online and/or digital environments owner and/or leasing, renting, using, owning, transacting, and/or management or renting entity for, the damage, deletion, corruption, unauthorized use, usage, creation, consumption, transaction, and/or storage, etc., of an improper nature. An exchange-of-risk-for-consideration provider or an underwriter will also, at step 93, assume responsibility for, and effect payment for any post-warranty, guaranty, service-level-agreement, and/or performance-assurance repairs and/or replacements, if such coverage is in effect. If, however, coverage is not triggered at step 92, an exchange-of-risk-for-consideration provider or underwriter will, at step 94, have no liability and/or loss to the online and/or digital environments owner and/or leasing, renting, using, owning, transacting, and/or management or renting entity.

At step 95, it will be determined if an incentive agreement for providing is in effect. If no incentive an agreement for providing is in effect, the operation of the apparatus and/or process will cease at step 96. If, at step 95, it is determined that an incentive agreement for providing is in effect, the apparatus 100 will, at step 97, determine the amount of the rebate and/or returned premium which is to be returned to the individual and/or entity. At step 98, the individual and/or entity will receive the rebate.

If no usage, creation, consumption, transaction, and/or storage and/or no damage has been found to exist, the individual and/or entity will receive the full rebate amount at step 98. If damage, deletion, corruption, unauthorized use, usage, creation, consumption, transaction, and/or storage, etc., of an improper nature has been found to exist at, or above, a pre-defined amount, the individual and/or entity will receive no rebate at step 98. If damage, deletion, corruption, unauthorized use, usage, creation, consumption, transaction, and/or storage, etc., of an improper nature has been found to exist below a pre-defined limit, a rebate amount will be calculated according to a pre-defined calculation and/or interpolation routine and the individual and/or entity will receive the calculated amount at step 98.

In the preferred embodiment, a linear interpolation routine is utilized to calculate the partial rebate amount at step 98. It is important to note that any mathematical computation routine and/or interpolation routine, linear or non-linear, as well as any other method for calculating an amount, or a partial amount, may be utilized in the processing scheme of the present invention. As noted above, rebate calculations will be performed during step 97.

Once the individual and/or entity has been issued their or its rebate, the liability and/or loss of an exchange-of-risk-for-consideration provider and/or underwriter will cease at step 99. The operation and method of the present invention will then cease at step 100.

The apparatus and method of the present invention may utilize any conventional techniques and/or an exchange-of-risk-for-consideration agreement for providing calculation and/or determination methods, in performing any of the processing functions described herein. The above-described methods, in the preferred embodiment, are implemented with computer programs and/or software programs. It is also noted that the method of the present invention may also be practiced manually and/or without a computer.

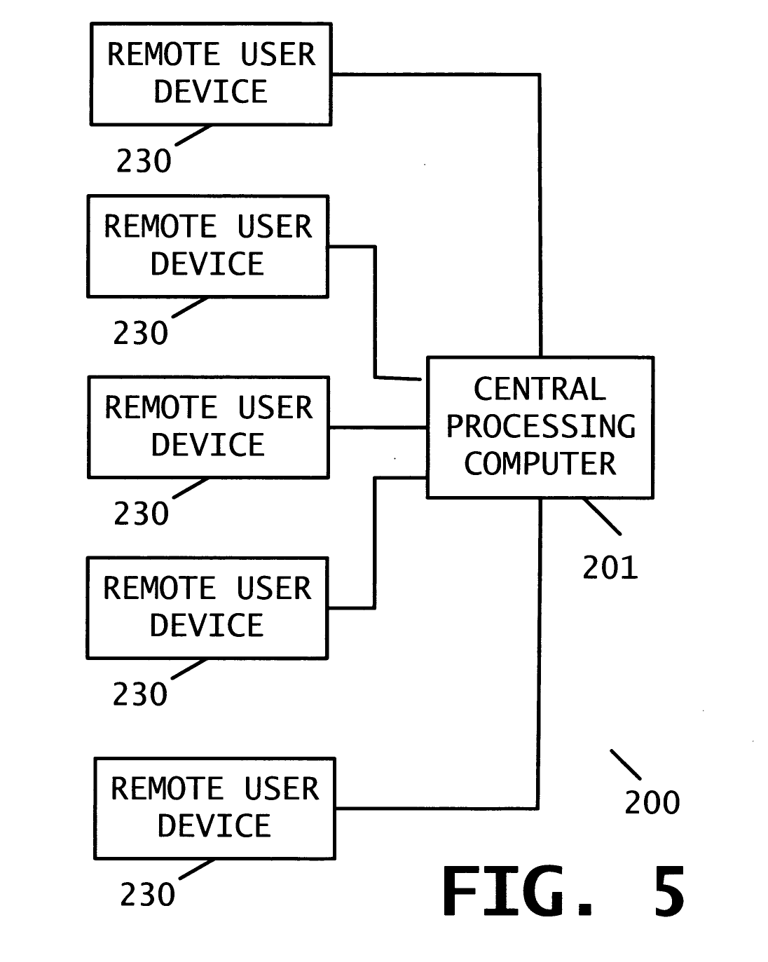

In another embodiment, the apparatus of the present invention is utilized in a network environment so as to provide exchange-of-risk-for-consideration policies, products, services and/or coverage in a network environment such as on, or over, the Internet, the World Wide Web and/or any other communications network and/or system. FIG. 5 illustrates the apparatus of the present invention in another embodiment wherein the apparatus is utilized in conjunction with a communications network.

FIG. 5 illustrates a block diagram of another embodiment of the apparatus of the present invention which is denoted generally by the reference numeral 200. As illustrated in FIG. 5, the apparatus 200 comprises a central processing computer 201 and a plurality of remote user computers, terminals and/or communication devices 230 (hereinafter referred to as “remote user device 230”). The central processing computer 201 may be a personal computer, a server computer, a workstation computer, a mainframe computer, a minicomputer or any other suitable computer processing system which is utilized in a network environment. The central processing computer 201 comprises all essential network devices and/or network interfacing devices, etc., for facilitating network operation. The central processing computer 201 may be fully and/or partially implemented as any one or more than one of a multitude of computing devices, servers, mobile devices, laptop computers, hand-held computers, gaming devices, storage area networks, personal area networks, in datacenters, managed networks, and accessed by any suitable device and/or utilized in conjunction with the Internet, Worldwide Web, intranets, extranets, and various other computational and/or communications networks.

Each of the remote user devices 230 is connected and/or linked with the central processing computer 201 via a communication network or medium. In the preferred embodiment, the communication network or medium is a telecommunication and/or telephone communication network. The telecommunication and/or telephone network may be a wire-line communication network, physical conduit enabled communication network, a terrestrial network, a non-terrestrial network, a satellite network, a mobile network, a morphing network, and/or a wireless communication network. In another embodiment, the apparatus 200 is utilized in conjunction with a local area network (LAN), a wide area network (WAN), a value added network (VAN) or any other communication network. In yet another embodiment, the apparatus 200 is utilized on, or over, and/or in conjunction with, the Internet and/or the World Wide Web.

It is important to note that the communication network and/or medium which may be utilized in conjunction with the apparatus and method of the present invention may be any suitable communication system and/or network for transmitting information and/or data, including multimedia, video, and/or audio information and/or data, or any other suitable information and/or data. In this regard, the communication network and/or medium may be a radio communication network or system, a digital communication network or system, a satellite communication network or system, a cable television communication network or system, a personal communications services (PCS) network or system, a telecommunication network or system, an optical communication network or system, and/or any other suitable communication network(s) and/or system(s), and/or any combination(s) thereof.

The communications system utilized may operate anywhere in the electromagnetic and/or radio signal frequency spectrum. As noted above, wireless communication networks and associated wireless communications devices, including wireless modems, may be utilized in conjunction with the present invention.

It is also important to note that the central processing computer 201 and remote user device(s) 230, which may be utilized, in the preferred embodiment, are equipped with the respective and/or corresponding communication equipment for transmitting and/or receiving the signals, data and/or information associated with the utilized communication network, and/or system, and/or any combination(s) thereof.

In the preferred embodiment, the central processing computer 201 is a typical central processing and/or server computer such as those utilized in conjunction with an on-line service and/or in network environments such as those utilized in conjunction with the Internet, the World Wide Web and/or any other suitable communication network or network environment. In the preferred embodiment, the remote user device 230 is a personal computer (PC) which may be a home or personal computer and/or a laptop computer.

While a personal computer is described as being utilized in the preferred embodiment, it is also envisioned that the remote user device 230 or devices may also be any suitable communication device, such as a personal communication device and/or a personal communication services (PCS) device, a personal digital assistant, a video telephone, a cellular telephone, a wire-line communication network, physical conduit enabled telephone, a wireless or cordless telephone, a digital communication device, a digital telephone, a digital television and/or an interactive television and/or any other suitable communication device. In this regard, the present invention may be utilized with any suitable device(s) for facilitating communications and/or data and/or information transfer in conjunction with the central processing computer 201 in any suitable communications and/or network environment.

The apparatus 200 is utilized in the same manner as described above with regards to FIGS. 1 to 4 so as to provide access to the apparatus and method of the present invention by remote users. In this regard any user may access the central processing computer 201 from any remote computer, terminal and/or other suitable communication device, so as to perform any of the herein-described processing routines for processing and calculating an exchange-of-risk-for-consideration premium, plan or an agreement for providing. In this regard, a central database (not shown) which is located at the central processing computer 201 would contain all of the data and/or information which is stored in the database 7 of the embodiment of FIG. 1 as described above. Further, the apparatus and method of the present invention facilitates on-line and/or network dissemination of exchange-of-risk-for-consideration policies, products, services and/or coverage so as to allow an individual and/or entity to obtain an exchange-of-risk-for-consideration and/or information related thereto for leased, rented, used, owned, transacted, service provided, and/or managed entities, from a remote location on, or over, a network environment, such as on, or over, the Internet, the World Wide Web, and/or any other suitable communication network.

In another embodiment, the apparatus and method of the present invention can be utilized in order to create a derivative credit products and/or services which is based on any liability and/or loss or liabilities which can be created by, or which can be potentially created by, any of the lease, rental, use, ownership, transaction, service providing, and/or management exchange-of-risk-for-consideration policies, products, and/or instruments, which can be provided pursuant to, and/or facilitated by, the present invention.

The derivative credit products and/or services can be created by an exchange-of-risk-for-consideration company, seller, originator, and/or broker of exchange-of-risk-for-consideration agreements, or other issuer, of any of the lease, rental, use, ownership, transaction, service providing, and/or management exchange-of-risk-for-consideration policies or lease, rental, use, ownership, transaction, service providing, and/or management exchange-of-risk-for-consideration products which are described herein as being generated, established, or issued, pursuant to the utilization of the present invention. The derivative credit products and/or services or derivative credit products and/or services can be utilized so as to allow the respective an exchange-of-risk-for-consideration company, seller, originator, and/or broker of exchange-of-risk-for-consideration agreements, or other issuer, to off-set the risk associated with its liability and/or loss or risk of loss, to limit its liability and/or loss or risk of loss, and/or to obtain an exchange-of-risk-for-consideration or an exchange-of-risk-for-consideration, for any liability and/or loss or liabilities and/or potential liability and/or loss or potential liabilities which may be associated with and/or which may result from the issuance of any of the herein-described lease, rental, use, ownership, transaction, service providing, and/or management exchange-of-risk-for-consideration policies or lease, rental, use, ownership, transaction, service providing, and/or management exchange-of-risk-for-consideration products.

The derivative credit products and/or services or derivative credit products and/or services can be utilized so as to allow the respective an exchange-of-risk-for-consideration company, seller, originator, and/or broker of exchange-of-risk-for-consideration agreements, or other issuer, to obtain a degree a degree of an exchange-of-risk-for-consideration or an exchange-of-risk-for-consideration for any liabilities which may be created by, or which may potentially be created by, any lease, rental, use, ownership, transaction, service providing, and/or management exchange-of-risk-for-consideration agreement for providing or lease, rental, use, ownership, transaction, service providing, and/or management exchange-of-risk-for-consideration policies described herein.

The derivative credit products and/or services or derivative credit products and/or services can be created for any one lease, rental, use, ownership, transaction, service providing, and/or management exchange-of-risk-for-consideration agreement for providing or lease, rental, use, ownership, transaction, service providing, and/or management exchange-of-risk-for-consideration product or for any number of lease, rental, use, ownership, transaction, service providing, and/or management exchange-of-risk-for-consideration policies or any number of lease, rental, use, ownership, transaction, service providing, and/or management exchange-of-risk-for-consideration products. The derivative credit products and/or services or derivative credit products and/or services can be created for any type of lease, rental, use, ownership, transaction, service providing, and/or management exchange-of-risk-for-consideration agreement for providing or lease, rental, use, ownership, transaction, service providing, and/or management exchange-of-risk-for-consideration product or for any types of lease, rental, use, ownership, transaction, service providing, and/or management exchange-of-risk-for-consideration policies or any number of lease, rental, use, ownership, transaction, service providing, and/or management exchange-of-risk-for-consideration products.

Applicant hereby incorporates by reference herein the subject matter and teachings of The Handbook Of Credit Derivatives, Jack Clark Francis, et al., McGraw Hill, 1999; Credit Derivatives: Trading & Management Of Credit & Default Risk, Satyajit Das, Wiley 1998, for the purpose of incorporating into this application the teachings of the above references which describe the types of credit derivatives, the uses and applications of credit derivatives, the use of credit derivatives in portfolio management, the use of credit derivatives in risk management, the pricing of credit derivatives, and the valuation of credit derivatives, and the manner in which credit derivatives can be implemented, priced and utilized.

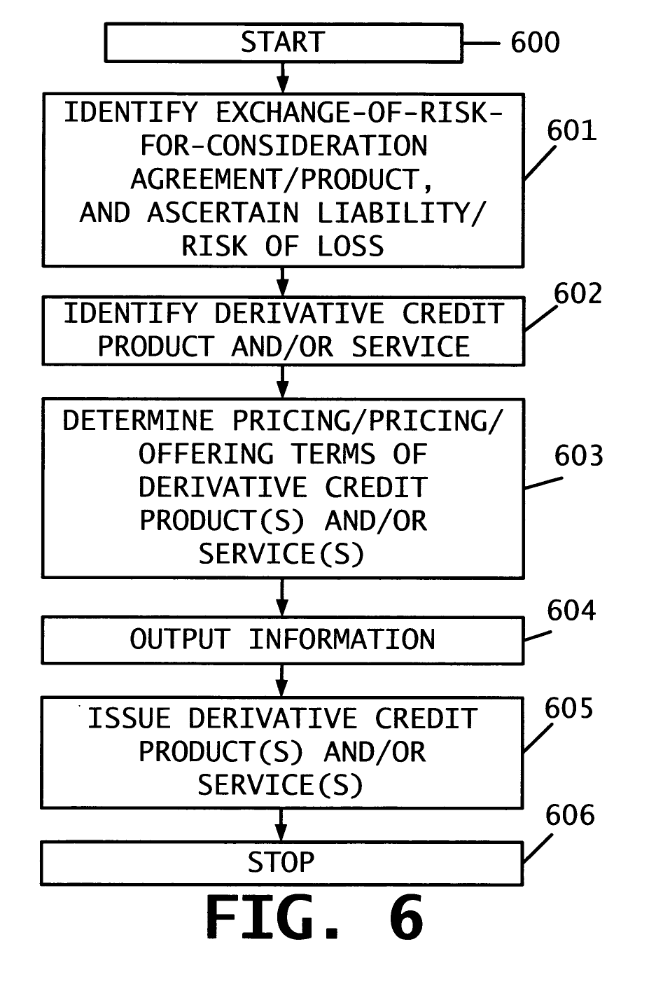

FIG. 6 illustrates a flow diagram of a method for utilizing the present invention in order to create and/or to price a derivative credit product and/or service corresponding to any liability and/or loss or potential liability and/or loss associated with a lease, rental, use, ownership, transaction, service providing, and/or management exchange-of-risk-for-consideration-agreement or lease, rental, use, ownership, transaction, service providing, and/or management exchange-of-risk-for-consideration product. With reference to FIG. 6, the method commences at step 600. At step 601, the central processing computer 100 will identify the lease, rental, use, ownership, transaction, service providing, and/or management exchange-of-risk-for-consideration agreement for providing or lease, rental, use, ownership, transaction, service providing, and/or management exchange-of-risk-for-consideration product which is being offered and can ascertain the liability and/or loss, the potential liability and/or loss, or the risk of loss, which is or which may be associated with the lease, rental, use, ownership, transaction, service providing, and/or management exchange-of-risk-for-consideration agreement for providing or the lease, rental, use, ownership, transaction, service providing, and/or management exchange-of-risk-for-consideration product.

At step 602, the central processing computer 100 can identify a derivative credit products and/or services which can be created and issued to investors in order to reduce the liability and/or loss or risk of loss associated with the lease, rental, use, ownership, transaction, service providing, and/or management exchange-of-risk-for-consideration agreement for providing or product. The derivative credit products and/or services can be any one or more of a bond, a note, a securitized bond, a securitized note, a exchange, a credit exchange, an option, a credit option, a put option, a call option, a credit-linked note, a total return exchange, a default exchange, an exotic option, an exotic credit option, a exchange-of-liabilities option, a total rate of return exchange-of-liabilities, a loan exchange-of-liabilities, a credit exchange-of-liabilities, or any other instrument which can be utilized as a derivative credit product and/or service.

At step 603, the central processing computer 100 can determine the price or pricing of the derivative credit products and/or services, derivative credit products and/or services, or derivative credit products and/or services units, for the derivative credit products and/or services identified at step 602. At step 603, the central processing computer 100 can also determine and/or generate the offering terms (e.g. time for holding the derivative credit products and/or services, time to maturity of the derivative credit products and/or services instrument, interest rate of the derivative credit products and/or services, rate of return of the derivative credit products and/or services, default risk information, issuer default risk, probability of default by the issuer of the derivative credit products and/or services, probability of non-default by the issuer, and any other terms or information which can be typically provided along with a derivative credit products and/or services or other investment or pecuniary instrument, etc.).

At step 604, the central processing computer 100 can output the information generated at step 602 regarding the identified derivative credit products and/or services and the information generated at step 603 regarding the pricing and/or offering terms for the derivative credit products and/or services, derivative credit products and/or services, or derivative credit products and/or services units. At step 605, the issuer of the derivative credit products and/or services can issue the derivative credit products and/or services to investors. Thereafter, the method of FIG. 6 will cease at step 606.

While the present invention has been described and illustrated in various preferred and alternate embodiments, such descriptions are merely illustrative of the present invention and are not to be construed to be limitations thereof. In this regard, the present invention encompasses all modifications, variations and/or alternate embodiments with the scope of the present invention being limited only by the claims which follow.

What is claimed is:

1. An apparatus for processing an exchange-of-risk-for-consideration request, comprising: a memory device for storing a first data set, the first data set containing information for generating any one of, or more than one of, an exchange-of-risk-for-consideration premium and an exchange-of-risk-for-consideration agreement for providing an exchange-of-risk-for-consideration for usage, creation, consumption, transaction, and/or storage for a leased, rented, used, owned, transacted, and/or managed entity; a processor for processing the first data set in conjunction with a second data set and a third data set, the second data set containing information regarding any one of, or more than one of, the entity to be leased, rented, used, owned, transacted, and/or managed entity and/or a term and/or terms of the lease, rental, use, ownership, transaction, and/or management, and the third data set containing information regarding any one of, or more than one of, a usage history of the leasing, renting, using, owning, transacting, and/or management individual and/or entity, an exchange-of-risk-for-consideration history of the leasing, renting, using, owning, transacting, and/or management individual, an exchange-of-risk-for-consideration history of the leasing, renting, using, owning, transacting, and/or management entity, a past leasing, renting, using, owning, transacting, and/or management history of the leasing, renting, using, owning, transacting, and/or management individual and/or entity past leasing, renting, using, owning, transacting, and/or management history of the leasing, renting, using, owning, transacting, and/or management individual and/or entity, a desired lease, rental, use, ownership, transaction, service providing, and/or management exchange-of-risk-for-consideration coverage, a lease, rental, use, ownership, transaction, service providing, and/or management exchange-of-risk-for-consideration deductible, and a lease, rental, use, ownership, transaction, service providing, and/or management exchange-of-risk-for-consideration-agreement term, the processor generating a fourth data set containing any one of, or more than one of, an exchange-of-risk-for-consideration premium and an exchange-of-risk-for-consideration agreement for providing any one of, or more than one of, an exchange-of-risk-for-consideration agreement and an exchange-of-risk-for-consideration product for usage, creation, consumption, transaction, and/or storage for the leased, rented, used, owned, transacted, and/or managed entity; and a device for any one of, or more than one of, displaying and outputting information contained in any one of, or more than one of, the fourth data set, an exchange-of-risk-for-consideration premium, an exchange-of-risk-for-consideration agreement, and an exchange-of-risk-for-consideration product, the processor generating a fifth data set containing information regarding any one of, or more than one of, a liability and/or loss, a potential liability and/or loss, and a risk of loss, associated with the any one of, or more than one of, an exchange-of-risk-for-consideration agreement and an exchange-of-risk-for-consideration product.

2. The apparatus of claim 1, wherein the entity being any one of, or more than one of, digital assets, digital entities, digital identities, digital currencies, applications, applets, digital audio, digital video, digital text, data, information, algorithms, programs, online stores, virtual worlds, avatars, virtual characters, electronic books, video files, e-magazines, e-tickets, e-documents, chat rooms, internet forums, virtual communities, virtual artifacts, virtual weapons, virtual tools, digital currencies, units of economic value/monetary value/actual currencies and/or monetary units stored in online and/or digital accounts, which are invested saved, wagered, used, stored/transacted in online and/or digital accounts and/or transactions, computational processes, commands, and/or programs, etc., which exist in games, and/or gaming, and/or entertainment, and/or education, and/or business, and/or as elements of other forms of utility in digital environments which may be assets in commerce, entertainment, gaming, music, video, and the like, which constitute an asset, and/or class of assets, in digital form, any other supporting and/or enabling assets, such as but not limited to, software, hardware, computing infrastructure, network infrastructure, network connections, professional services, and/or the providers, terms, contracting parties, and/or any other relevant supporting and/or enabling asset data and/or information, and any online and/or digital environment.

3. The apparatus of claim 1, the memory device further containing information related to a repair cost, a replacement cost, a probability of damage, a probability of post-warranty, guaranty, service-level-agreement, and/or performance-assurance repair, historical leasing, renting, using, owning, transacting, and/or management information, one of locality, regional, geographical, and seasonal, information corresponding to the lease, a usage pattern, a usage habit, a developer's, designer's, service provider's, product supplier's, and/or manufacturer's warranty, guaranty, service-level-agreement, and/or performance-assurance, a lease, rental, use, ownership, transaction, service providing, and/or management term, a lease, rental, use, ownership, transaction, service providing, and/or management duration, historical repair information, repair frequency information, an exchange-of-risk-for-consideration agreement for providing information, an exchange-of-risk-for-consideration premium information, an exchange-of-risk-for-consideration product information, an exchange-of-risk-for-consideration service information, an exchange-of-risk-for-consideration premium rebate incentive program, an exchange-of-risk-for-consideration premium rebate incentive information, actuarial information, statistical information, risk information, and risk of loss information, with respect to any one of, or more than one of, digital assets, digital entities, digital identities, digital currencies, applications, applets, digital audio, digital video, digital text, data, information, algorithms, programs, online stores, virtual worlds, avatars, virtual characters, electronic books, video files, e-magazines, e-tickets, e-documents, chat rooms, internet forums, virtual communities, virtual artifacts, virtual weapons, virtual tools, digital currencies, units of economic value/monetary value/actual currencies and/or monetary units stored in online and/or digital accounts, which are invested saved, wagered, used, stored/transacted in online and/or digital accounts and/or transactions, computational processes, commands, and/or programs, etc., which exist in games, and/or gaming, and/or entertainment, and/or education, and/or business, and/or as elements of other forms of utility in digital environments which may be assets in commerce, entertainment, gaming, music, video, and the like, which constitute an asset, and/or class of assets, in digital form, any other supporting and/or enabling assets, such as but not limited to, software, hardware, computing infrastructure, network infrastructure, network connections, professional services, and/or the providers, terms, contracting parties, and/or any other relevant supporting and/or enabling asset data and/or information, and any online and/or digital environment.

4. The apparatus of claim 1, the third data set containing information regarding an exchange-of-risk-for-consideration premium rebate incentive, and the processor generating the forth data set containing any one of, or more than one of, information, an exchange-of-risk-for-consideration premium, an exchange-of-risk-for-consideration agreement for providing, and an exchange-of-risk-for-consideration product, containing any one of, or more than one of, a premium rebate incentive feature and an premium rebate incentive provision.

5. The apparatus of claim 4, the processor determining whether the any one of, or more than one of, a premium rebate incentive feature and an premium rebate incentive provision is in effect, and the processor calculating an amount of an exchange-of-risk-for-consideration premium to be refunded.

6. The apparatus of claim 1, further comprising: an input device for inputting information contained in any one of, or more than one of, the first data set, the second data set, and the third data set, and the one of a display device and an output device facilitating a presentation of any one of, or more than one of, information contained in the fourth data set, an exchange-of-risk-for-consideration premium, an exchange-of-risk-for-consideration agreement for providing, an exchange-of-risk-for-consideration product, to a prospective an agreement for providing holder.

7. The apparatus of claim 1, further comprising: a receiver for receiving a request for information contained in any one of, or more than one of, the first data set, the second data set, the third data set, the fourth data set, and the fifth data set, from a remote communication device; and a transmitter for transmitting information contained in any one of, or more than one of, the first data set, the second data set, the third data set, the fourth data set, and the fifth data set, to the remote communication device in response to said request.

8. The apparatus of claim 1, wherein the processor identifies a derivative credit products and/or services for any one of, or more than one of, providing a hedging position, providing an exchange-of-risk-for-consideration, and providing an exchange-of-risk-for-consideration, for the any one of, or more than one of, a liability and/or loss, a potential liability and/or loss, and a risk of loss, associated with the any one of, or more than one of, an exchange-of-risk-for-consideration agreement and an exchange-of-risk-for-consideration product.

9. The apparatus of claim 1, wherein the processor determines any one of, or more than one of, a price, pricing information, and offering terms, for a derivative credit products and/or services, the derivative credit products and/or services any one of, or more than one of, providing a hedging position, providing an exchange-of-risk-for-consideration, and providing an exchange-of-risk-for-consideration, for the any one of, or more than one of, a liability and/or loss, a potential liability and/or loss, and a risk of loss, associated with the any one of, or more than one of, an exchange-of-risk-for-consideration agreement and an exchange-of-risk-for-consideration product.

10. The apparatus of claim 1, wherein the device for any one of, or more than one of, displaying and/or outputting information concerning a derivative credit products and/or services, the derivative credit products and/or services any one of, or more than one of, providing a hedging position, providing an exchange-of-risk-for-consideration, and providing an exchange-of-risk-for-consideration, for the any one of, or more than one of, a liability and/or loss, a potential liability and/or loss, and a risk of loss, associated with the any one of, or more than one of, an exchange-of-risk-for-consideration agreement and an exchange-of-risk-for-consideration product.

11. An apparatus for processing an exchange-of-risk-for-consideration request, comprising: a memory device for storing a first data set, the first data set containing information for generating any one of, or more than one of, an exchange-of-risk-for-consideration premium and an exchange-of-risk-for-consideration agreement for providing an exchange-of-risk-for-consideration for post-warranty, post-guaranty, concluded and/or terminated service-level-agreement, and/or concluded and/or terminated performance-assurance repairs and/or replacements for a leased, rented, used, owned, transacted, and/or managed entity; a processor for processing the first data set in conjunction with a second data set and a third data set, the second data set containing information regarding any one of, or more than one of, the entity to be leased, rented, used, owned, transacted, and/or managed entity and/or a term and/or terms of the lease, rental, use, ownership, transaction, and/or management, and the third data set containing information regarding any one of, or more than one of, a leasing, renting, using, owning, transacting, and/or management history of the leasing, renting, using, owning, transacting, and/or management individual and/or entity leasing, renting, using, owning, transacting, and/or management history of the leasing, renting, using, owning, transacting, and/or management entity, a usage history of the leasing, renting, using, owning, transacting, and/or management individual and/or entity usage history of the leasing, renting, using, owning, transacting, and/or management entity, an exchange-of-risk-for-consideration history of the leasing, renting, using, owning, transacting, and/or management individual, an exchange-of-risk-for-consideration history of the leasing, renting, using, owning, transacting, and/or management entity, a past leasing, renting, using, owning, transacting, and/or management history of the leasing, renting, using, owning, transacting, and/or management individual and/or entity past leasing, renting, using, owning, transacting, and/or management history of the leasing, renting, using, owning, transacting, and/or management entity, a desired lease, rental, use, ownership, transaction, service providing, and/or management exchange-of-risk-for-consideration coverage, a lease, rental, use, ownership, transaction, service providing, and/or management exchange-of-risk-for-consideration deductible, and a lease, rental, use, ownership, transaction, service providing, and/or management exchange-of-risk-for-consideration-agreement term, the processor generating a fourth data set containing any one of, or more than one of, an exchange-of-risk-for-consideration premium and an exchange-of-risk-for-consideration agreement for providing any one of, or more than one of, an exchange-of-risk-for-consideration agreement and an exchange-of-risk-for-consideration product for post-warranty, post-guaranty, concluded and/or terminated service-level-agreement, and/or concluded and/or terminated performance-assurance repairs and/or replacements for the leased, rented, used, owned, transacted, and/or managed entity; a device for any one of, or more than one of, displaying and outputting information contained in any one of, or more than one of, the fourth data set, an exchange-of-risk-for-consideration premium, an exchange-of-risk-for-consideration agreement for providing, and an exchange-of-risk-for-consideration product, the processor generating a fifth data set containing information regarding any one of, or more than one of, a liability and/or loss, a potential liability and/or loss, and a risk of loss, associated with the any one of, or more than one of, an exchange-of-risk-for-consideration agreement and an exchange-of-risk-for-consideration product.

12. The apparatus of claim 11, wherein the entity being any one of, or more than one of, digital assets, digital entities, digital identities, digital currencies, applications, applets, digital audio, digital video, digital text, data, information, algorithms, programs, online stores, virtual worlds, avatars, virtual characters, electronic books, video files, e-magazines, e-tickets, e-documents, chat rooms, internet forums, virtual communities, virtual artifacts, virtual weapons, virtual tools, digital currencies, units of economic value/monetary value/actual currencies and/or monetary units stored in online and/or digital accounts, which are invested saved, wagered, used, stored/transacted in online and/or digital accounts and/or transactions, computational processes, commands, and/or programs, etc., which exist in games, and/or gaming, and/or entertainment, and/or education, and/or business, and/or as elements of other forms of utility in digital environments which may be assets in commerce, entertainment, gaming, music, video, and the like, which constitute an asset, and/or class of assets, in digital form, any other supporting and/or enabling assets, such as but not limited to, software, hardware, computing infrastructure, network infrastructure, network connections, professional services, and/or the providers, terms, contracting parties, and/or any other relevant supporting and/or enabling asset data and/or information, and any online and/or digital environment.

13. The apparatus of claim 11, the memory device further containing information related to a repair cost, a replacement cost, a probability of damage, a probability of post-warranty, guaranty, service-level-agreement, and/or performance-assurance repair, historical leasing, renting, using, owning, transacting, and/or management information, one of locality, regional, geographical, and seasonal, information corresponding to the lease, a usage pattern, a usage habit, a developer's, designer's, service provider's, product supplier's, and/or manufacturer's warranty, guaranty, service-level-agreement, and/or performance-assurance, a lease, rental, use, ownership, transaction, service providing, and/or management term, a lease, rental, use, ownership, transaction, service providing, and/or management duration, historical repair information, repair frequency information, an exchange-of-risk-for-consideration agreement for providing information, an exchange-of-risk-for-consideration premium information, an exchange-of-risk-for-consideration product information, an exchange-of-risk-for-consideration service information, an exchange-of-risk-for-consideration premium rebate incentive program, an exchange-of-risk-for-consideration premium rebate incentive information, actuarial information, statistical information, risk information, and risk of loss information, with respect to any one of, or more than one of, digital assets, digital entities, digital identities, digital currencies, applications, applets, digital audio, digital video, digital text, data, information, algorithms, programs, online stores, virtual worlds, avatars, virtual characters, electronic books, video files, e-magazines, e-tickets, e-documents, chat rooms, interne forums, virtual communities, virtual artifacts, virtual weapons, virtual tools, digital currencies, units of economic value/monetary value/actual currencies and/or monetary units stored in online and/or digital accounts, which are invested saved, wagered, used, stored/transacted in online and/or digital accounts and/or transactions, computational processes, commands, and/or programs, etc., which exist in games, and/or gaming, and/or entertainment, and/or education, and/or business, and/or as elements of other forms of utility in digital environments which may be assets in commerce, entertainment, gaming, music, video, and the like, which constitute an asset, and/or class of assets, in digital form, any other supporting and/or enabling assets, such as but not limited to, software, hardware, computing infrastructure, network infrastructure, network connections, professional services, and/or the providers, terms, contracting parties, and/or any other relevant supporting and/or enabling asset data and/or information, and any online and/or digital environment.

14. The apparatus of claim 11, the third data set containing information regarding an exchange-of-risk-for-consideration premium rebate incentive, and the processor generating the forth data set containing any one of, or more than one of, information, an exchange-of-risk-for-consideration premium, an exchange-of-risk-for-consideration agreement for providing, and an exchange-of-risk-for-consideration product, containing any one of, or more than one of, a premium rebate incentive feature and an premium rebate incentive provision.

15. The apparatus of claim 14, the processor determining whether the any one of, or more than one of, a premium rebate incentive feature and an premium rebate incentive provision is in effect, and the processor calculating an amount of an exchange-of-risk-for-consideration premium to be refunded.

16. The apparatus of claim 11, further comprising: an input device for inputting information contained in any one of, or more than one of, the first data set, the second data set, and the third data set, and the one of a display device and an output device facilitating a presentation of any one of, or more than one of, information contained in the fourth data set, an exchange-of-risk-for-consideration premium, an exchange-of-risk-for-consideration agreement for providing, an exchange-of-risk-for-consideration product, to a prospective an agreement for providing holder.

17. The apparatus of claim 11, further comprising: a receiver for receiving a request for information contained in any one of, or more than one of, the first data set, the second data set, the third data set, the fourth data set, and the fifth data set, from a remote communication device; and a transmitter for transmitting information contained in any one of, or more than one of, the first data set, the second data set, the third data set, the fourth data set, and the fifth data set, to the remote communication device in response to said request.

18. The apparatus of claim 11, wherein the processor identifies a derivative credit products and/or services for any one of, or more than one of, providing a hedging position, providing an exchange-of-risk-for-consideration, and providing an exchange-of-risk-for-consideration, for the any one of, or more than one of, a liability and/or loss, a potential liability and/or loss, and a risk of loss, associated with the any one of, or more than one of, an exchange-of-risk-for-consideration agreement and an exchange-of-risk-for-consideration product.

19. The apparatus of claim 11, wherein the processor determines any one of, or more than one of, a price, pricing information, and offering terms, for a derivative credit products and/or services, the derivative credit products and/or services any one of, or more than one of, providing a hedging position, providing an exchange-of-risk-for-consideration, and providing an exchange-of-risk-for-consideration, for the any one of, or more than one of, a liability and/or loss, a potential liability and/or loss, and a risk of loss, associated with the any one of, or more than one of, an exchange-of-risk-for-consideration agreement and an exchange-of-risk-for-consideration product, and further wherein the device for any one of, or more than one of, displaying and/or outputting information concerning the derivative credit products and/or services.

20. A method for processing an exchange-of-risk-for-consideration request, comprising the storing of a first data set, the first data set containing information for generating any one of, or more than one of, an exchange-of-risk-for-consideration premium and an exchange-of-risk-for-consideration agreement for providing an exchange-of-risk-for-consideration for usage, creation, consumption, transaction, and/or storage for a leased, rented, used, owned, transacted, and/or managed entity; the processing of the first data set in conjunction with a second data set and a third data set, the second data set containing information regarding any one of, or more than one of, the entity to be leased, rented, used, owned, transacted, and/or managed entity and/or a term and/or terms of the lease, rental, use, ownership, transaction, and/or management, and the third data set containing information regarding any one of, or more than one of, a usage history of the leasing, renting, using, owning, transacting, and/or management individual and/or entity, an exchange-of-risk-for-consideration history of the leasing, renting, using, owning, transacting, and/or management individual, an exchange-of-risk-for-consideration history of the leasing, renting, using, owning, transacting, and/or management entity, a past leasing, renting, using, owning, transacting, and/or management history of the leasing, renting, using, owning, transacting, and/or management individual and/or entity past leasing, renting, using, owning, transacting, and/or management history of the leasing, renting, using, owning, transacting, and/or management individual and/or entity, a desired lease, rental, use, ownership, transaction, service providing, and/or management exchange-of-risk-for-consideration coverage, a lease, rental, use, ownership, transaction, service providing, and/or management exchange-of-risk-for-consideration deductible, and a lease, rental, use, ownership, transaction, service providing, and/or management exchange-of-risk-for-consideration-agreement term, the processor generating a fourth data set containing any one of, or more than one of, an exchange-of-risk-for-consideration premium and an exchange-of-risk-for-consideration agreement for providing any one of, or more than one of, an exchange-of-risk-for-consideration agreement and an exchange-of-risk-for-consideration product for usage, creation, consumption, transaction, and/or storage for the leased, rented, used, owned, transacted, and/or managed entity; the displaying and outputting information contained in any one of, or more than one of, the fourth data set, an exchange-of-risk-for-consideration premium, an exchange-of-risk-for-consideration agreement, and an exchange-of-risk-for-consideration product, the processor generating a fifth data set containing information regarding any one of, or more than one of, a liability and/or loss, a potential liability and/or loss, and a risk of loss, associated with the any one of, or more than one of, an exchange-of-risk-for-consideration agreement and an exchange-of-risk-for-consideration product.

21. The method of claim 20, wherein the entity being processed, stored, transmitted is any one of, or more than one of, digital assets, digital entities, digital identities, digital currencies, applications, applets, digital audio, digital video, digital text, data, information, algorithms, programs, online stores, virtual worlds, avatars, virtual characters, electronic books, video files, e-magazines, e-tickets, e-documents, chat rooms, internet forums, virtual communities, virtual artifacts, virtual weapons, virtual tools, digital currencies, units of economic value/monetary value/actual currencies and/or monetary units stored in online and/or digital accounts, which are invested saved, wagered, used, stored/transacted in online and/or digital accounts and/or transactions, computational processes, commands, and/or programs, etc., which exist in games, and/or gaming, and/or entertainment, and/or education, and/or business, and/or as elements of other forms of utility in digital environments which may be assets in commerce, entertainment, gaming, music, video, and the like, which constitute an asset, and/or class of assets, in digital form, any other supporting and/or enabling assets, such as but not limited to, software, hardware, computing infrastructure, network infrastructure, network connections, professional services, and/or the providers, terms, contracting parties, and/or any other relevant supporting and/or enabling asset data and/or information, and any online and/or digital environment.

22. The method of claim 20, wherein storing of information includes information related to any one of, or more than one of, a repair cost, a replacement cost, a probability of damage, a probability of post-warranty, guaranty, service-level-agreement, and/or performance-assurance repair, historical leasing, renting, using, owning, transacting, and/or management information, one of locality, regional, geographical, and seasonal, information corresponding to the lease, a usage pattern, a usage habit, a developer's, designer's, service provider's, product supplier's, and/or manufacturer's warranty, guaranty, service-level-agreement, and/or performance-assurance, a lease, rental, use, ownership, transaction, service providing, and/or management term, a lease, rental, use, ownership, transaction, service providing, and/or management duration, historical repair information, repair frequency information, an exchange-of-risk-for-consideration agreement for providing information, an exchange-of-risk-for-consideration premium information, an exchange-of-risk-for-consideration product information, an exchange-of-risk-for-consideration service information, an exchange-of-risk-for-consideration premium rebate incentive program, an exchange-of-risk-for-consideration premium rebate incentive information, actuarial information, statistical information, risk information, and risk of loss information, with respect to any one of, or more than one of, digital assets, digital entities, digital identities, digital currencies, applications, applets, digital audio, digital video, digital text, data, information, algorithms, programs, online stores, virtual worlds, avatars, virtual characters, electronic books, video files, e-magazines, e-tickets, e-documents, chat rooms, internet forums, virtual communities, virtual artifacts, virtual weapons, virtual tools, digital currencies, units of economic value/monetary value/actual currencies and/or monetary units stored in online and/or digital accounts, which are invested saved, wagered, used, stored/transacted in online and/or digital accounts and/or transactions, computational processes, commands, and/or programs, etc., which exist in games, and/or gaming, and/or entertainment, and/or education, and/or business, and/or as elements of other forms of utility in digital environments which may be assets in commerce, entertainment, gaming, music, video, and the like, which constitute an asset, and/or class of assets, in digital form, any other supporting and/or enabling assets, such as but not limited to, software, hardware, computing infrastructure, network infrastructure, network connections, professional services, and/or the providers, terms, contracting parties, and/or any other relevant supporting and/or enabling asset data and/or information, and any online and/or digital environment.

23. The method of claim 20, further comprising the storing of the third data set containing information regarding an exchange-of-risk-for-consideration premium rebate incentive, and the processor generating the forth data set containing any one of, or more than one of, information, an exchange-of-risk-for-consideration premium, an exchange-of-risk-for-consideration agreement for providing, and an exchange-of-risk-for-consideration product, containing any one of, or more than one of, a premium rebate incentive feature and an premium rebate incentive provision.

24. The method of claim 23, further comprising the processing for determining whether the any one of, or more than one of, a premium rebate incentive feature and an premium rebate incentive provision is in effect, and the processor calculating an amount of an exchange-of-risk-for-consideration premium to be refunded.

25. The method of claim 20, further comprising the inputting of information contained in any one of, or more than one of, the first data set, the second data set, and the third data set, and the one of a display device and an output device facilitating a presentation of any one of, or more than one of, information contained in the fourth data set, an exchange-of-risk-for-consideration premium, an exchange-of-risk-for-consideration agreement for providing, an exchange-of-risk-for-consideration product, to a prospective an agreement for providing holder.

26. The method of claim 20, further comprising the receiving a request for information contained in any one of, or more than one of, the first data set, the second data set, the third data set, the fourth data set, and the fifth data set, from a remote communication device; and transmitting information contained in any one of, or more than one of, the first data set, the second data set, the third data set, the fourth data set, and the fifth data set, to the remote communication device in response to said request.

27. The method of claim 20, further comprising the identification of derivative credit products and/or services for any one of, or more than one of, providing a hedging position, providing an exchange-of-risk-for-consideration, and providing an exchange-of-risk-for-consideration, for the any one of, or more than one of, a liability and/or loss, a potential liability and/or loss, and a risk of loss, associated with the any one of, or more than one of, an exchange-of-risk-for-consideration agreement and an exchange-of-risk-for-consideration product.

28. The method of claim 20, further comprising determining any one of, or more than one of, a price, pricing information, and offering terms, for a derivative credit products and/or services, the derivative credit products and/or services any one of, or more than one of, providing a hedging position, providing an exchange-of-risk-for-consideration, and providing an exchange-of-risk-for-consideration, for the any one of, or more than one of, a liability and/or loss, a potential liability and/or loss, and a risk of loss, associated with the any one of, or more than one of, an exchange-of-risk-for-consideration agreement and an exchange-of-risk-for-consideration product.

29. The method of claim 20, further comprising the displaying and/or outputting of information concerning a derivative credit products and/or services, the derivative credit products and/or services any one of, or more than one of, providing a hedging position, providing an exchange-of-risk-for-consideration, and providing an exchange-of-risk-for-consideration, for the any one of, or more than one of, a liability and/or loss, a potential liability and/or loss, and a risk of loss, associated with the any one of, or more than one of, an exchange-of-risk-for-consideration agreement and an exchange-of-risk-for-consideration product.

30. A method for processing an exchange-of-risk-for-consideration request, comprising: a memory device for storing a first data set, the first data set containing information for generating any one of, or more than one of, an exchange-of-risk-for-consideration premium and an exchange-of-risk-for-consideration agreement for providing an exchange-of-risk-for-consideration for post-warranty, post-guaranty, concluded and/or terminated service-level-agreement, and/or concluded and/or terminated performance-assurance repairs and/or replacements for a leased, rented, used, owned, transacted, and/or managed entity; a processor for processing the first data set in conjunction with a second data set and a third data set, the second data set containing information regarding any one of, or more than one of, the entity to be leased, rented, used, owned, transacted, and/or managed entity and/or a term and/or terms of the lease, rental, use, ownership, transaction, and/or management, and the third data set containing information regarding any one of, or more than one of, a leasing, renting, using, owning, transacting, and/or management history of the leasing, renting, using, owning, transacting, and/or management individual and/or entity leasing, renting, using, owning, transacting, and/or management history of the leasing, renting, using, owning, transacting, and/or management entity, a usage history of the leasing, renting, using, owning, transacting, and/or management individual and/or entity usage history of the leasing, renting, using, owning, transacting, and/or management entity, an exchange-of-risk-for-consideration history of the leasing, renting, using, owning, transacting, and/or management individual, an exchange-of-risk-for-consideration history of the leasing, renting, using, owning, transacting, and/or management entity, a past leasing, renting, using, owning, transacting, and/or management history of the leasing, renting, using, owning, transacting, and/or management individual and/or entity past leasing, renting, using, owning, transacting, and/or management history of the leasing, renting, using, owning, transacting, and/or management entity, a desired lease, rental, use, ownership, transaction, service providing, and/or management exchange-of-risk-for-consideration coverage, a lease, rental, use, ownership, transaction, service providing, and/or management exchange-of-risk-for-consideration deductible, and a lease, rental, use, ownership, transaction, service providing, and/or management exchange-of-risk-for-consideration-agreement term, the processor generating a fourth data set containing any one of, or more than one of, an exchange-of-risk-for-consideration premium and an exchange-of-risk-for-consideration agreement for providing any one of, or more than one of, an exchange-of-risk-for-consideration agreement and an exchange-of-risk-for-consideration product for post-warranty, post-guaranty, concluded and/or terminated service-level-agreement, and/or concluded and/or terminated performance-assurance repairs and/or replacements for the leased, rented, used, owned, transacted, and/or managed entity; a device for any one of, or more than one of, displaying and outputting information contained in any one of, or more than one of, the fourth data set, an exchange-of-risk-for-consideration premium, an exchange-of-risk-for-consideration agreement for providing, and an exchange-of-risk-for-consideration product, the processor generating a fifth data set containing information regarding any one of, or more than one of, a liability and/or loss, a potential liability and/or loss, and a risk of loss, associated with the any one of, or more than one of, an exchange-of-risk-for-consideration agreement and an exchange-of-risk-for-consideration product.

31. The method of claim 30, wherein the entity being processed, stored, transmitted is any one of, or more than one of, digital assets, digital entities, digital identities, digital currencies, applications, applets, digital audio, digital video, digital text, data, information, algorithms, programs, online stores, virtual worlds, avatars, virtual characters, electronic books, video files, e-magazines, e-tickets, e-documents, chat rooms, internet forums, virtual communities, virtual artifacts, virtual weapons, virtual tools, digital currencies, units of economic value/monetary value/actual currencies and/or monetary units stored in online and/or digital accounts, which are invested saved, wagered, used, stored/transacted in online and/or digital accounts and/or transactions, computational processes, commands, and/or programs, etc., which exist in games, and/or gaming, and/or entertainment, and/or education, and/or business, and/or as elements of other forms of utility in digital environments which may be assets in commerce, entertainment, gaming, music, video, and the like, which constitute an asset, and/or class of assets, in digital form, any other supporting and/or enabling assets, such as but not limited to, software, hardware, computing infrastructure, network infrastructure, network connections, professional services, and/or the providers, terms, contracting parties, and/or any other relevant supporting and/or enabling asset data and/or information, and any online and/or digital environment.

32. The method of claim 30, wherein storing of information includes information related to any one of, or more than one of, repair cost, a replacement cost, a probability of damage, a probability of post-warranty, guaranty, service-level-agreement, and/or performance-assurance repair, historical leasing, renting, using, owning, transacting, and/or management information, one of locality, regional, geographical, and seasonal, information corresponding to the lease, a usage pattern, a usage habit, a developer's, designer's, service provider's, product supplier's, and/or manufacturer's warranty, guaranty, service-level-agreement, and/or performance-assurance, a lease, rental, use, ownership, transaction, service providing, and/or management term, a lease, rental, use, ownership, transaction, service providing, and/or management duration, historical repair information, repair frequency information, an exchange-of-risk-for-consideration agreement for providing information, an exchange-of-risk-for-consideration premium information, an exchange-of-risk-for-consideration product information, an exchange-of-risk-for-consideration service information, an exchange-of-risk-for-consideration premium rebate incentive program, an exchange-of-risk-for-consideration premium rebate incentive information, actuarial information, statistical information, risk information, and risk of loss information, with respect to any one of, or more than one of, digital assets, digital entities, digital identities, digital currencies, applications, applets, digital audio, digital video, digital text, data, information, algorithms, programs, online stores, virtual worlds, avatars, virtual characters, electronic books, video files, e-magazines, e-tickets, e-documents, chat rooms, internet forums, virtual communities, virtual artifacts, virtual weapons, virtual tools, digital currencies, units of economic value/monetary value/actual currencies and/or monetary units stored in online and/or digital accounts, which are invested saved, wagered, used, stored/transacted in online and/or digital accounts and/or transactions, computational processes, commands, and/or programs, etc., which exist in games, and/or gaming, and/or entertainment, and/or education, and/or business, and/or as elements of other forms of utility in digital environments which may be assets in commerce, entertainment, gaming, music, video, and the like, which constitute an asset, and/or class of assets, in digital form, any other supporting and/or enabling assets, such as but not limited to, software, hardware, computing infrastructure, network infrastructure, network connections, professional services, and/or the providers, terms, contracting parties, and/or any other relevant supporting and/or enabling asset data and/or information, and any online and/or digital environment.

33. The method of claim 30, further comprising the storing of the third data set containing information regarding an exchange-of-risk-for-consideration premium rebate incentive, and the processor generating the forth data set containing any one of, or more than one of, information, an exchange-of-risk-for-consideration premium, an exchange-of-risk-for-consideration agreement for providing, and an exchange-of-risk-for-consideration product, containing any one of, or more than one of, a premium rebate incentive feature and an premium rebate incentive provision.

34. The method of claim 33, further comprising the determining of whether the any one of, or more than one of, a premium rebate incentive feature and an premium rebate incentive provision is in effect, and the processor calculating an amount of an exchange-of-risk-for-consideration premium to be refunded.

35. The method of claim 30, further comprising inputting information contained in any one of, or more than one of, the first data set, the second data set, and the third data set, and the one of a display device and an output device facilitating a presentation of any one of, or more than one of, information contained in the fourth data set, an exchange-of-risk-for-consideration premium, an exchange-of-risk-for-consideration agreement for providing, an exchange-of-risk-for-consideration product, to a prospective an agreement for providing holder.

36. The method of claim 30, further comprising receiving a request for information contained in any one of, or more than one of, the first data set, the second data set, the third data set, the fourth data set, and the fifth data set, from a remote communication device; and a transmitter for transmitting information contained in any one of, or more than one of, the first data set, the second data set, the third data set, the fourth data set, and the fifth data set, to the remote communication device in response to said request.

37. The method of claim 30, further comprising the identifying of derivative credit products and/or services for any one of, or more than one of, providing a hedging position, providing an exchange-of-risk-for-consideration, and providing an exchange-of-risk-for-consideration, for the any one of, or more than one of, a liability and/or loss, a potential liability and/or loss, and a risk of loss, associated with the any one of, or more than one of, an exchange-of-risk-for-consideration agreement and an exchange-of-risk-for-consideration product.

38. The method of claim 30, further comprising determining of any one of, or more than one of, a price, pricing information, and offering terms, for a derivative credit products and/or services, the derivative credit products and/or services any one of, or more than one of, providing a hedging position, providing an exchange-of-risk-for-consideration, and providing an exchange-of-risk-for-consideration, for the any one of, or more than one of, a liability and/or loss, a potential liability and/or loss, and a risk of loss, associated with the any one of, or more than one of, an exchange-of-risk-for-consideration agreement and an exchange-of-risk-for-consideration product, and further wherein the device for any one of, or more than one of, displaying and/or outputting information concerning the derivative credit products and/or services.
